(19) United States
(12) Patent Application Publication
(10) Pub. No.: US 2022/0277356 A1
(43) Pub. Date: Sep. 1, 2022

(54) SYSTEMS AND METHODS FOR ASSOCIATING ADVERTISERS AND CONTENT CREATORS

(71) Applicant: Invite Technologies, Inc., Massapequa, NY (US)

(72) Inventors: Brianna Michelle RUSSO, Massapequa, NY (US); Anthony Joseph NAPOLITANO, Massapequa, NY (US); Anthony Edward NAPOLITANO, Massapequa, NY (US)

(73) Assignee: Invite Technologies, Inc., Massapequa, NY (US)

(21) Appl. No.: 17/683,194

(22) Filed: Feb. 28, 2022

Related U.S. Application Data
(60) Provisional application No. 63/154,726, filed on Feb. 27, 2021.

(51) Int. Cl. G06Q 30/02; G06Q 50/00

(52) U.S. Cl. CPC G06Q 30/0277; G06Q 30/0269; G06Q 50/01

(57) ABSTRACT

An embodiment of the present disclosure is a system and method for associating advertisers with content creators. The system and method may include determining an association between an advertiser preference profile associated with an advertiser and a user preference profile associated with a content creator to facilitate matching the advertiser with the content creator for an advertiser campaign.

### CROSS-REFERENCE TO RELATED APPLICATIONS

The present application claims the benefit of and priority to U.S. Provisional Application No. 63/154,726, filed on Feb. 27, 2021, the entire disclosure of which is incorporated by reference into the present application.

### BACKGROUND

The present disclosure relates to a system for associating advertisers and content creators and related methods.

Social media networks may include one or more content creators that have developed reputations as having some level of influence with some number of fans/followers. These personalities have come to be called “social media content creators” given the impact such personalities appear to have on their followers and the social media networks themselves.

The subject matter described herein generally relates to the field of marketing, specifically including functions related to digital marketing deep-insight metrics and software implementations and tools that may allow for measuring performance obligations of content creators working on an advertiser campaign based on content value, reach and/or engagement rate. As content creator marketing matures and solidifies its position as a staple in a wider marketing vision, there may be a use for structuring the system to address legal disclosure requirements, perhaps for example when it comes to newer social media platforms, such as TikTok, where there is still uncertainty among brands about the best ways to utilize it. One or more techniques may use multistep flows of communication with “characteristics of innovation” that may impact one or more stages in the decision-making process of an advertiser campaign.

Digital and social media environments have transformed the way advertisers reach consumers as the most ‘buzzed-about’ figure in the twenty-first century of marketing thus far has been the ‘digital content creator,’ industry dialect for Instagrammers', TikTokers', and other social media account platforms. Notably, Instagram remains a highly desired platform for ‘content creator marketing,’ whilst, TikTok starts to take market share. Content creator marketing has taken a significant role in the overall marketing strategy of advertisers. Although celebrities are content creators for major advertisers, they are more costly for smaller advertisers to recruit for marketing their products. As a result, the popularity of ‘micro-influencers’ has risen as a new branch of desired content creators. In general, content creators can range from celebrities to more micro-targeted professional or non-professional peers. Advertiser campaigns and marketing activities are often tailored to a particular content creator. Micro-influencers allow versatility for an advertiser and can facilitate targeted advertiser campaigns toward a specific group of consumers without excessive costs.

Micro-influencers are content creators who are not as well-known as celebrities, but who have strong and enthusiastic followings that are usually more targeted, amounting anywhere between a few thousand to hundreds of thousands of followers. For example, content creator marketing facilitates connection of online personas with advertiser brands or services that target audiences who trust them with their regular engagement. As a result, content creators have grown in importance as their decisions on their social media platforms shape consumer opinions on products, brands and issues. This growing responsibility highlights the importance of this type of brand communication on consumer reactions and provides opportunities to innovate the conventional marketing model to optimize marketing effectiveness, while protecting consumers from being misled by hidden advertising.

The rise of content creator marketing has allowed it to supplement or replace other marketing avenues that have been impacted by the growth of advertisement blocking movements. As a result, advertisers must pivot to embrace the importance of content creator marketing. Content creators play the role of vital intermediaries that help connect advertisers and brands with consumers on social media platforms in a highly resonant, authentic manner which provides measurable outcomes and has shown to be successful. As content creator marketing matures and solidifies its position as an integral part of any advertiser's wider marketing strategy, it becomes essential for advertisers to embrace this movement to run successful advertiser campaigns for products and services associated with its brand. Advertisers and brands are already increasing their digital marketing budgets and the amount of money they dedicate toward establishing effective channels of content creator marketing.

Consumers dislike advertisements and pay to avoid seeing them, thus, creating a large problem in the advertising industry. The media continues to shift our perception on what to think as more users engage with daily social media platforms. Smaller advertisers in the advertising industry struggle with the lack of an effective process to find content creators to promote their products. As a result, they end up giving away too much product. Current advertising models are often flawed and inefficient. Conventional models are restrictive and often require multi-layer adaptation to discover the true target audience. Furthermore, they do not address important concerns such as protecting customer data in accordance with privacy laws, advertising regulations, and a consumer's right to privacy. Conventional models are often costly because they do not allow for content creator marketing to be directly managed by the advertiser or handle compensation and revenue associated with an advertiser campaign. There exists a need for a streamlined system that provides a direct payment system for content creators and advertisers and accurately measures outcomes of completed advertiser campaigns using machine learning and AI to optimize their use of content creator marketing to effectively reach consumers of their brand.

As the marketing industry matures, advertisers need to take a serious look at their measurement methodologies and hold their content creator marketing programs to the same standards as their other marketing investments. Despite this, many advertisers remain focused on driving top-of-the-funnel brand awareness, impressions and engagements with less emphasis on tracking content creator marketing efforts to sales. As digital platforms offer interactive campaign management capabilities with immediate, direct feedback and conversations with opinion leaders or content creators, multiple flows of communication will lead the future of marketing efforts, as influence on social media platforms is unique and ranges from mega content creators to micro content creators.

As a result of the rise of content creator marketing, the marketing industry needs a marketing platform to account for content creator marketing. The marketing industry also needs to be cognizant of the growing need for authenticity and the need for trust and protection associated with privacy concerns that reflect the ever-changing digital and social media landscape that advertisers currently face.

There is a need for a system for directly associating advertisers and content creators through, for example, a digital marketing software platform. Conventional software platforms do not effectively match advertisers and content creators. As a result, there is a need for a system that utilizes an algorithm to effectively match, e.g., associate content creators with advertisers. The problem addressed by the present disclosure stems from recognition of qualitative research on this largely uncharted territory of ‘content creator marketing’ as it relates to the current advertising industry.

### SUMMARY

There is a need for a system and method of associating advertisers and content creators capable of efficiently connecting advertisers and content creators that addresses the aforementioned problems of conventional systems and methods.

An embodiment of the present disclosure is a method performed by at least one control device, the control device being in communication with a communications network. The method includes receiving, by the control device, one or more advertiser campaign proposals via the communications network. The method also includes determining, by the control device, one or more social media provider networks adapted for at least one of the one or more advertiser campaign proposals. The method also includes determining, by the control device, at least one social media content creator associated with at least one of the one or more social media provider networks. The method also includes associating, by the control device, the at least one social media content creator with a producer of at least one of the one or more advertiser campaign proposals.

Another embodiment of the present disclosure is a method that includes obtaining an advertiser preference profile for social media content creators with a software application running on one or more computing devices, wherein the advertiser preference profile includes a desired value of one or more attributes associated with social media content creators. The method also includes accessing a database of social media content creators, the database including a generated value corresponding to each social media content creator, wherein the generated value corresponds to the one or more attributes associated with social media content creators. The method also includes determining an association between the desired value and the generated value of at least one of the social media content creators. The method also includes, based on the association between the desired value and the generated value, identifying one or more social media content creators from a plurality of social media content creators obtained from the database.

Another embodiment of the present disclosure is a system comprising a content creator database of one or more social media content creators, an advertiser database of one or more advertiser campaign proposals, and a software application. The one or more social media content creators each include a plurality of predetermined user preferences and a plurality of user attributes associated with a social networking profile of each social media content creator. The one or more advertiser campaign proposals each include a plurality of predetermined advertiser preferences and a plurality of advertiser attributes associated with a business profile of each advertiser campaign proposal. The software application is configured to obtain a user preference profile for social media content creators, wherein the user preference profile includes the plurality of predetermined user preferences and the plurality of user attributes. The software application is also configured to obtain an advertiser preference profile for advertiser campaign proposals, wherein the advertiser preference profile includes the plurality of predetermined advertiser preferences and the plurality of advertiser attributes. The software application is also configured to determine an association between the advertiser preference profile and the user preference profile for the one or more social media content creators. The software application is also configured to, based on the association between the advertiser preference profile and the user preference profile for the one or more social media content creators, identify one or more social media content creators from a plurality of social media content creators obtained from the content creator database.

The systems and methods as described herein are not limited for use with advertisers and social media content creators.

### BRIEF DESCRIPTION OF THE DRAWINGS

The foregoing summary, as well as the following detailed description of illustrative embodiments of the present disclosure, will be better understood when read in conjunction with the appended drawings. For the purposes of illustrating the present application, there are shown in the drawings, illustrative embodiments of the disclosure. It should be understood, however, that the application is not limited to the precise arrangements and instrumentalities shown. In the drawings:

FIG. 1 is a block diagram illustrating an exemplary network environment operable to deliver electronic content throughout the network via one or more network devices, such as a consumer premises device (CPE) device, among other devices;

FIG. 2 is a block diagram of a hardware configuration of an example device applicable for associating advertisers with content creators, such as any of the CPE devices of FIG. 1;

FIG. 3 is a block diagram of a hardware configuration of an example device applicable for associating advertisers with content creators, such as a home gateway;

FIG. 4A is a diagram illustrating a system for associating an advertiser and a content creator according to another embodiment of the present disclosure;

FIG. 4B is a computing device associated with each advertiser and content creator illustrated in FIG. 4A;

FIG. 4C is a server computing device illustrated in FIG. 4A;

FIG. 5 is a schematic diagram illustrating functional components of a software application for associating an advertiser and a content creator implemented by one or more portions of the system according to various embodiments of the present disclosure;

FIG. 6 is a process flow diagram illustrating an exemplary method for associating an advertiser and a content creator according to an embodiment of the present disclosure;

FIG. 7 is a process flow diagram illustrating an exemplary method for associating an advertiser and a content creator according to an embodiment of the present disclosure;

FIG. 8 is a process flow diagram illustrating an exemplary method for associating an advertiser and content creator according to an embodiment of the present disclosure;

FIG. 9 illustrates an example graphical user interface wherein an advertiser and content creator utilize a direct payment method according to an embodiment of the present disclosure;

FIG. 10 illustrates an example graphical user interface wherein an advertiser and content creator are associated according to an embodiment of the present disclosure;

FIG. 11 illustrates an example graphical user interface wherein an advertiser and content creator identify predetermined preferences according to an embodiment of the present disclosure;

FIG. 12 illustrates an example graphical user interface wherein a location-based preference is incorporated into predetermined preferences according to an embodiment of the present disclosure;

FIG. 13 illustrates an example graphical user interface for viewing activities of an advertiser and a content creator for an advertiser campaign according to an embodiment of the present disclosure;

FIG. 14 illustrates an example graphical user interface for a content creator to identify preferences for an advertiser campaign according to an embodiment of the present disclosure;

FIG. 15 illustrates an example graphical user interface for a content creator to identify social media provider networks according to an embodiment of the present disclosure;

FIG. 16 illustrates an example graphical user interface for an advertiser to identify social media provider networks according to an embodiment of the present disclosure;

FIG. 17 illustrates an example graphical user interface wherein an advertiser and a content creator are associated according to an embodiment of the present disclosure;

FIG. 18 illustrates an example graphical user interface wherein an advertiser and a content creator directly connect according to an embodiment of the present disclosure;

FIG. 19 illustrates an example graphical user interface depicting advertiser campaigns associated with an advertiser according to an embodiment of the present disclosure;

FIG. 20 illustrates an example graphical user interface depicting advertiser campaigns associated with a content creator according to an embodiment of the present disclosure;

FIG. 21 illustrates an example graphical user interface depicting communications and obligations between an advertiser and a content creator for an advertiser campaign according to an embodiment of the present disclosure;

FIG. 22 illustrates an example graphical user interface identifying outcomes associated with a completed advertiser campaign according to an embodiment of the present disclosure;

FIG. 23 illustrates an example graphical user interface identifying obligations for a content creator in an advertiser campaign according to an embodiment of the present disclosure;

FIG. 24 illustrates an example graphical user interface of an agreement between an advertiser and a content creator for an advertiser campaign according to an embodiment of the present disclosure;

FIG. 25A illustrates an example graphical user interface depicting previous advertiser campaigns associated with an advertiser and/or a content creator according to an embodiment of the present disclosure;

FIG. 25B illustrates an example graphical user interface depicting previous advertiser campaigns associated with an advertiser and/or a content creator according to an embodiment of the present disclosure;

FIG. 26 illustrates an example graphical user interface depicting a profile of a content creator according to an embodiment of the present disclosure; and

FIG. 27 illustrates an example graphical user interface depicting the use of blockchain technology in connection with an advertiser campaign according to an embodiment of the present disclosure.

### DETAILED DESCRIPTION OF ILLUSTRATIVE EMBODIMENTS

Embodiments of the present disclosure include a system, method, and related software applications for acquisition and analysis of predetermined preferences and attributes to associate an advertiser and a content creator. The systems, methods, and related software applications as described herein may be used to recommend a content creator from a content creator database. It should be appreciated that systems, methods, and software applications are configured to recommend other items, such as products.

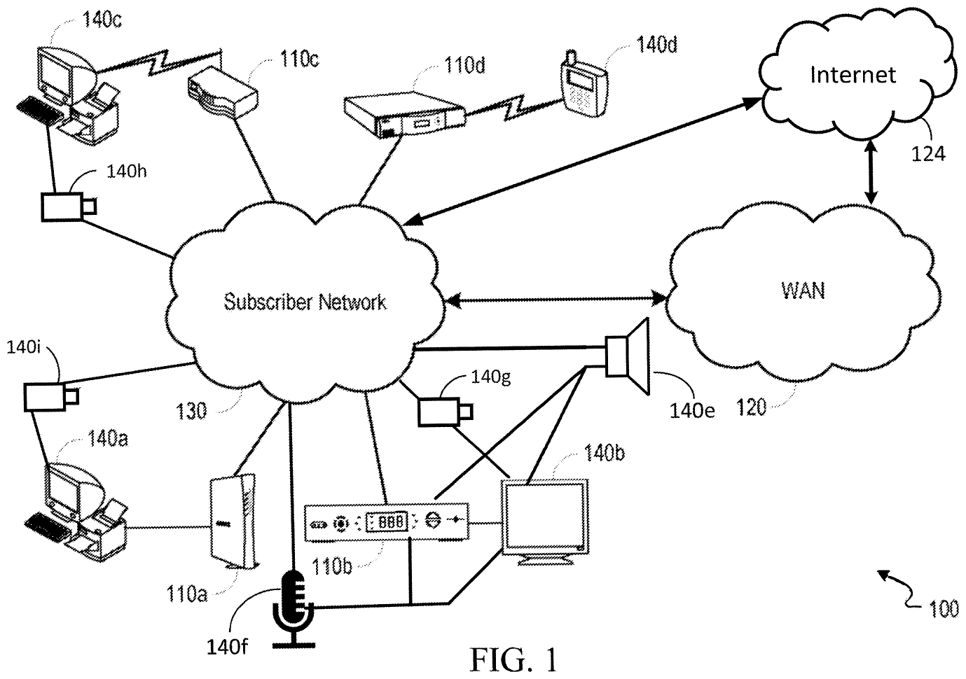

FIG. 1 is a block diagram illustrating an example network environment 100 operable for electronic content delivery. Electronic content may include media content, electronic documents, device-to-device communications, streaming media content, Internet/cloud-based electronic applications/services/databases, electronic communications/services (e.g., video/audio conferencing), Internet-based electronic services, virtual reality content and/or services, augmented reality content and/or services, media captioning content and/or services, electronic commerce, video components/elements of electronic content, and/or audio components/elements of electronic content, among other types of electronic content.

A media content delivery network operator, or MSO, may deliver media content to subscribers/viewers. Media content may be provided via a consumer premise equipment (CPE) and/or network gateway device supported by the MSO, for example. In one or more scenarios, CPE devices 110a-d receive video service(s) and/or data service(s) from a wide area network (WAN) 120 via a connection to a subscriber network 130. The one or more nodes of subscriber network 130 and/or the WAN 120 may communicate with one or more cloud-based nodes (not shown) via the Internet 124. The subscriber network 130 and/or WAN 120 may include a home gateway (not shown), that may be used to implement set-top box functionality, among other functions.

The CPE devices can include, for example, a modem 110a, a set-top box 110b, a wireless router including an embedded modem 110c, or a media gateway 110d, among many others (e.g., digital subscriber line (DSL) modem, voice over internet protocol (VOIP) terminal adapter, video game console, digital versatile disc (DVD) player, communications device, hotspot device, etc.). The subscriber network 130, for example, can be a hybrid fiber-coaxial (HFC) network, a local area network (LAN), a wireless local area network (WLAN), a cellular network, a personal area network (PAN), as well as others. As used herein, a media control device may be any of the devices 110a-110d and/or 140a-140i, an Internet Gateway, a router device, a set-top box (STB), a smart media device (SMD), a cloud computing device, any type of CPE, and/or any other suitable device (e.g., wired and/or wireless) that may be configured to perform one or more of the techniques and/or functionality disclosed herein, for example.

The CPE devices can facilitate communications between the WAN 120 and client devices 140a-140i. A cable modem or embedded MTA (eMTA) 110a can facilitate communications between the WAN 120 and a computer 140a. A set-top box 110b can facilitate communications between the WAN 120 and a television/monitor 140b (e.g., a media presentation device) and/or a digital video recorder (DVR). A wireless router 110c can facilitate communications between a computer 140c and the WAN 120.

The media gateway 110d can facilitate communications between a mobile device 140d (e.g., a tablet computing device, a smartphone, a personal digital assistant (PDA) device, a laptop computing device, etc.; one or more devices being PC-based, iOS-based, Linux-based, and/or Android-based, etc.) and the WAN 120. One or more speaker devices (e.g., sound radiation devices/systems) 140e may be in communication with the subscriber network 130, set-top box 110b, and/or television 140b, etc. Camera devices 140g, 140h, and/or 140i may be in communication with the computer 140a, the television 140b, the computer 140c, and/or the subscriber network 130, for example, among other devices and networks.

The one or more speaker devices 140e (e.g., surround sound speakers, home theater speakers, other external wired/wireless speakers, loudspeakers, full-range drivers, subwoofers, woofers, mid-range drivers, tweeters, coaxial drivers, etc.) may broadcast at least an audio component of electronic content/media content, among other audio signals/processes/applications. The one or more speaker devices 140e may possess the capability to radiate sound in pre-configured acoustical/physical patterns (e.g., a cone pattern, a directional pattern, etc.).

One or more microphone devices 140f may be external/standalone microphone devices. The one or more microphone devices 140f may be in communication with the subscriber network 130, set-top box 110b, television 140b, computer 140a, computer 140c, mobile device 140d, etc. Any of the client devices 110a-110d and/or devices 140a-140i may include internal microphone devices. The one or more speaker devices 140e (e.g., “speakers”) and/or the one or more microphone devices 140f (e.g., “microphones”, may be “high quality” devices such as far field microphones, noise-cancelling microphones, shotgun microphones, dynamic microphones, ribbon microphones, and/or various size diaphragm microphones, Bluetooth™ based remote/control devices, RF4CE-based remote/control devices, etc.) may have wired and/or wireless connections (e.g., Bluetooth, Wi-Fi, private protocol communication network, etc.) to any of the other devices 140a-140i, the subscriber network 130, the WAN 120, and/or the Internet 124.

The camera devices 140g-140i may provide digital video input/output capability for one or more of the devices 110a-110d and/or devices 140a-140d. The camera devices 140g-140i may communicate with any of the devices 110a-110d and/or devices 140a-140f, perhaps for example via a wired and/or wireless connection. One or more of the camera devices 140g-140i may capture digital images and/or may scan images of various kinds, such as Universal Product Code (UPC) codes and/or Quick Response (QR) codes, for example, among other images. One or more of the camera devices 140g-140i may provide for video input/output for video conferencing (e.g., may serve as webcams or the like), for example, among other video functions.

Any of the camera devices 140g-140i may include microphone devices and/or speaker devices. The input/output of any of the camera devices 140g-140i may include audio signals/packets/components, perhaps for example separate/separable from, or in some (e.g., separable) combination with, the video signals/packets/components of any of the camera devices 140g-140i.

One or more of the camera devices 140g-140i may detect the presence of one or more people that may be proximate to the camera devices 140g-140i and/or that may be in the same general space (e.g., the same room) as the camera devices 140g-140i. One or more of the camera devices 140g-140i may gauge a general activity level (e.g., high activity, medium activity, and/or low activity) of one or more people that may be detected by the camera devices 140g-140i. One or more of the camera devices 140g-140i may detect one or more general characteristics (e.g., height, body shape, facial features, pulse, heart rate, breathing count, etc.) of the one or more people detected by the camera devices 140g-140i. One or more of the camera devices 140g-140i may be configured to recognize one or more specific people, for example. One or more of the camera devices 140g-140i may be configured to detect a user's/viewer's attention/gaze toward/on a monitor/television device (e.g., detecting a location on the monitor/television device that may correspond to a user's/viewer's attention/gaze toward/on the monitor/television device).

One or more of the camera devices 140g-140i may use wireless communication with any of the devices 110a-110d and/or 140a-140d, such as for example Bluetooth™ and/or Wi-Fi™, among other wireless communication protocols. One or more of the camera devices 140g-140i may be external to any of the devices 110a-110d and/or devices 140a-140d. One or more of the camera devices 140g-140i may be internal to any of the devices 110a-110d and/or devices 140a-140d.

A user (not shown) may monitor (e.g., watch and/or listen to) and/or create media content and/or more generally interact with various kinds of electronic content on/from/via one or more of the devices 110a-110d and/or 140a-140i, among other devices (not shown), for example. The electronic content may be encrypted via one or more encryption techniques, such as symmetrical and/or asymmetrical encryption. Any of the devices 110a-110d and/or 140a-140i may utilize one or more digital certificates to initiate, and/or engage in, encrypted communication to obtain, interact, and/or monitor electronic content that may be conveyed via the Internet 124, the WAN 120, and/or the subscriber network 130, etc., for example.

For example, a CPE device, such as a set-top box 110b and/or any of the devices 110a-110d and/or 140a-140i, may be used to receive service from a network service provider. For various reasons, perhaps for example when a consumer engages a network service provider for a new service and/or a change in an existing service, and/or perhaps when a CPE device may be replaced (e.g., for maintenance, upgrade, etc.), one or more consumer profiles may be implemented on the CPE device (e.g., may need to be implemented).

In one or more scenarios, any of the devices 110a-110d, 140a-140i, among other devices, may be used by one or more media content (e.g., video) viewers/users to implement any of the capabilities, techniques, methods, and/or devices described herein.

The WAN network 120 and/or the subscriber network 130 may be implemented as any type of wired and/or wireless network, including a local area network (LAN), a wide area network (WAN), a global network (the Internet), etc. Accordingly, the WAN network 120 and/or the subscriber network 130 may include one or more communicatively coupled network computing devices (not shown) for facilitating the flow and/or processing of network communication traffic via a series of wired and/or wireless interconnects. Such network computing devices may include, but are not limited, to one or more access points, routers, switches, servers, computing devices, and/or storage devices, etc.

The communications, requests, determinations, and/or detections of associating one or more advertisers with one or more content creators can be transmitted and/or stored in one or more files, such as text files (e.g., Hypertext Transfer Protocol (HTTP) files), among other types of files.

In one or more scenarios, advertising content may include one or more of over-the-top (OTT) video, cable video, broadcast video, and/or satellite video, among other types of video content.

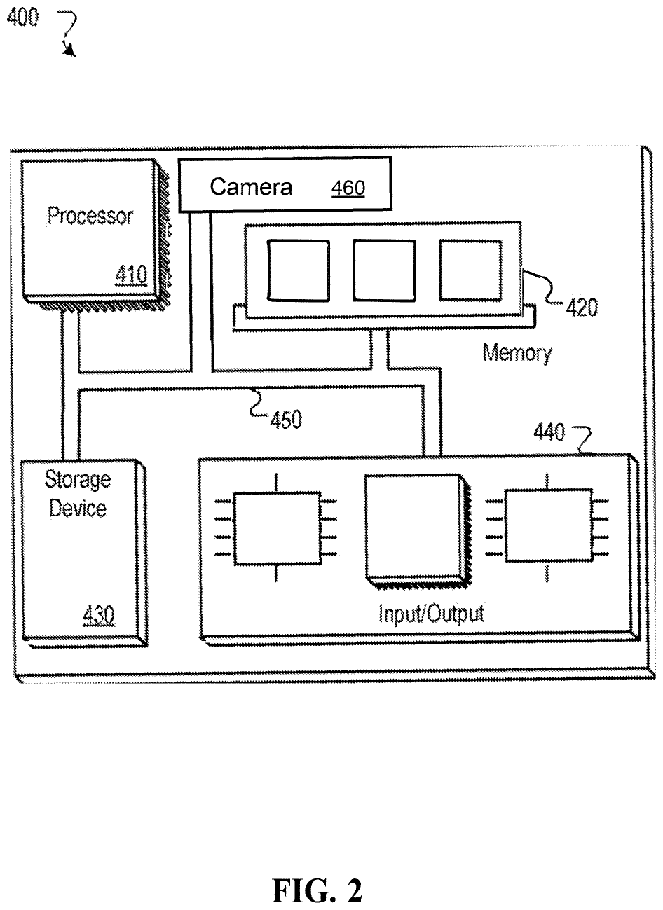

FIG. 2 is a block diagram of a hardware configuration of an example device that may deliver electronic content/media content (e.g., video and/or audio content/components of electronic content), such as the CPE device 110 of FIG. 1, among other devices such as 140a-140i, devices 110a-110d, for example. The hardware configuration 400 may be operable to facilitate delivery of information from an internal server of a device. The hardware configuration 400 can include a processor 410, a memory 420, a storage device 430, and/or an input/output device 440. One or more of the components 410, 420, 430, and 440 can, for example, be interconnected using a system bus 450. The processor 410 can process instructions for execution within the hardware configuration 400. The processor 410 can be a single-threaded processor or the processor 410 can be a multi-threaded processor. The processor 410 can be capable of processing instructions stored in the memory 420 and/or on the storage device 430.

The memory 420 can store information within the hardware configuration 400. The memory 420 can be volatile (such as some types of RAM), non-volatile (such as ROM, flash memory, etc.), or a combination thereof, depending upon the exact configuration and type of processor 410. The memory 420 can be a computer-readable medium (CRM), for example, a non-transitory CRM.

The storage device 430 can be capable of providing mass storage for the hardware configuration 400. The storage device 430 can be a computer-readable medium (CRM), for example, a non-transitory CRM. The storage device 430 can, for example, include additional storage (e.g., removable storage and/or non-removable storage) including, but not limited to, tape, flash memory, smart cards, CD-ROM, digital versatile disks (DVD) or other optical storage, magnetic cassettes, magnetic tape, magnetic storage or other magnetic storage devices, universal serial bus (USB) compatible memory, or any other medium which can be used to store information and which can be accessed by the hardware configuration 400. The storage device 430 can be a device external to the hardware configuration 400.

The input/output device 440 may provide input/output operations for the hardware configuration 400. The input/output device 440 (e.g., a transceiver device) can include one or more of a network interface device (e.g., an Ethernet card), a serial communication device (e.g., an RS-232 port), one or more universal serial bus (USB) interfaces (e.g., a USB 2.0 port) and/or a wireless interface device (e.g., an 802.11 card). The input/output device can include driver devices configured to send communications to, and/or receive communications from one or more networks (e.g., subscriber network 130 of FIG. 1).

A camera device 460 may provide digital video input/output capability for the hardware configuration 400. The camera device 460 may communicate with any of the elements of the hardware configuration 400, perhaps for example via system bus 450. The camera device 460 may capture digital images and/or may scan images of various kinds, such as Universal Product Code (UPC) codes and/or Quick Response (QR) codes, for example, among other images.

The camera device 460 may include at least one microphone device and/or at least one speaker device. The input/output of the camera device 460 may include audio signals/packets/components, perhaps for example separate/separable from, or in some (e.g., separable) combination with, the video signals/packets/components of the camera device 460.

The camera device 460 may also detect the presence of one or more people that may be proximate to the camera device 460 and/or may be in the same general space (e.g., the same room) as the camera device 460. The camera device 460 may gauge a general activity level (e.g., high activity, medium activity, and/or low activity) of one or more people that may be detected by the camera device 460. The camera device 460 may detect one or more general characteristics (e.g., height, body shape, facial features, pulse, heart rate, breathing count, etc.) of the one or more people detected by the camera device 460. The camera device 460 may be configured to recognize one or more specific people, for example.

The camera device 460 may be in wired and/or wireless communication with the hardware configuration 400. In one or more scenarios, the camera device 460 may be external to the hardware configuration 400. In one or more scenarios, the camera device 460 may be internal to the hardware configuration 400.

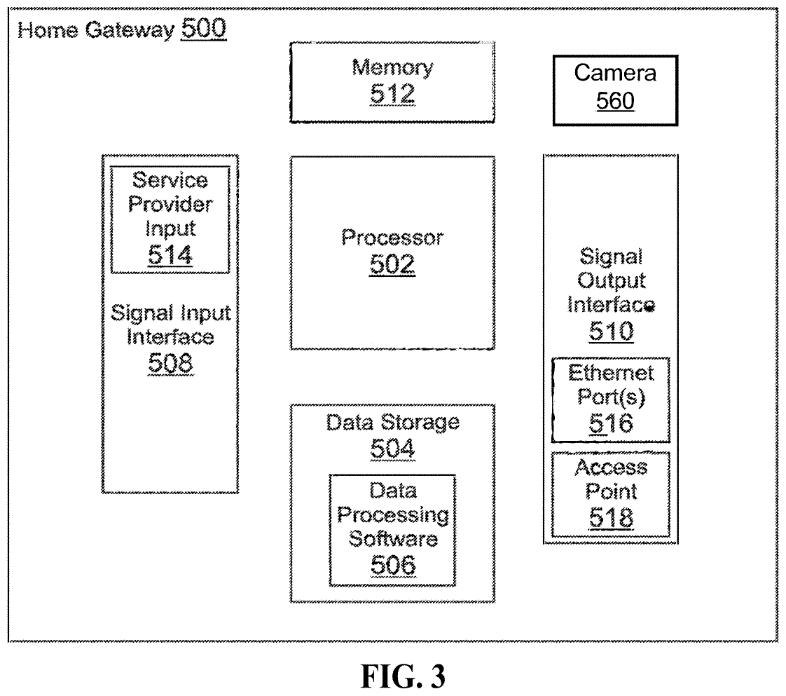

FIG. 3 is a block diagram of a hardware configuration of an example device that may deliver electronic content/media content (e.g., video and/or audio components of electronic content), such as a home gateway (e.g., an access point device), among other devices. A hardware configuration 500 (e.g., home gateway 500) may be constructed in a similar manner to hardware configuration 400 in that the architecture may be built around a general-purpose processor, processor 502, and/or an application specific chip set such as designed for use in a Data Over Cable Service Interface Specification (DOC SIS), a Gigabit Passive Optical Network (GPON), and/or a Digital Subscriber Line (DSL) modem. As with processor 410, the general-purpose processor 502 may also be an off-the-shelf processor. The functionality of the desired modem may be implemented through data processing software 506 stored in data storage 504 and/or may be run on processor 502.

Home gateway 500 may include signal input interface 508 and/or signal output interface 510. Signal input interface 508 may include, for example, circuitry to receive data inputs from a service provider at service provider input 514, e.g., a cable and/or a fiber optic input.

Signal output interface 510 may provide the output of the home gateway 500. Signal output interface 510 may provide signals in formats for transmission over a datalink. For example, interface 510 may include one or more Ethernet ports 516 and/or a wireless access point 518. It is to be understood that data may be communicated over wired and/or wireless networks. The access point 518 may be located external to the home gateway 500. Video and/or audio content received at signal input interface 508 can be streamed from home gateway 500 to hardware configuration 400, perhaps for example as another source of video and/or audio signal. This streaming may be accomplished over a reliable backhaul communication link (not shown) that may provide high video quality, perhaps for example for signals that are sensitive to latency in the signal (e.g., live programming). The signal input interface 508 and the signal output interface 510 may operate together, such as for example as a transceiver device.

In operation, a data signal may be received at signal input interface 508 of home gateway 500. Processor 502 may operate data processing software 506 on general-purpose processor 502 to prepare the received signals (e.g., code, decode, etc.). The output of the data processing software 506 may be output by signal output interface 510, e.g., Ethernet port 516 and/or wireless access point 518.

The camera device 560 may provide digital video input/output capability for the home gateway 500. The camera device 560 may communicate with any of the elements of the home gateway 500. The camera device 560 may capture digital images and/or may scan images of various kinds, such as Universal Product Code (UPC) codes and/or Quick Response (QR) codes, for example, among other images.

The camera device 560 may include at least one microphone device and/or at least one speaker device. The input/output of the camera device 560 may include audio signals/packets/components, perhaps for example separate/separable from, or in some (e.g., separable) combination with, the video signals/packets/components of the camera device 560.

The camera device 560 may also detect the presence of one or more people that may be proximate to the camera device 560 and/or may be in the same general space (e.g., the same room) as the camera device 560. The camera device 560 may gauge a general activity level (e.g., high activity, medium activity, and/or low activity) of one or more people that may be detected by the camera device 560. The camera device 560 may detect one or more general characteristics (e.g., height, body shape, facial features, pulse, heart rate, breathing count, etc.) of the one or more people detected by the camera device 560. The camera device 560 may be configured to recognize one or more specific people, for example.

The camera device 560 may be in wired and/or wireless communication with the home gateway 500. In one or more scenarios, the camera device 560 may be internal and/or external to the home gateway 500.

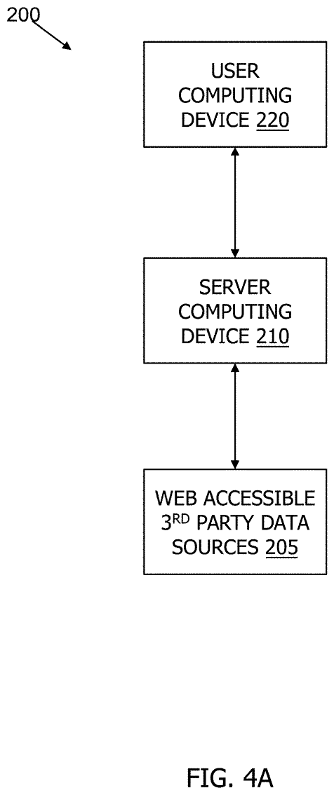

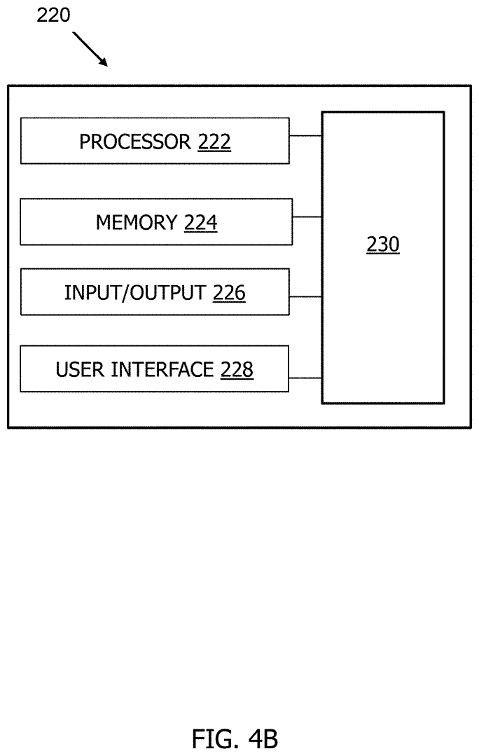

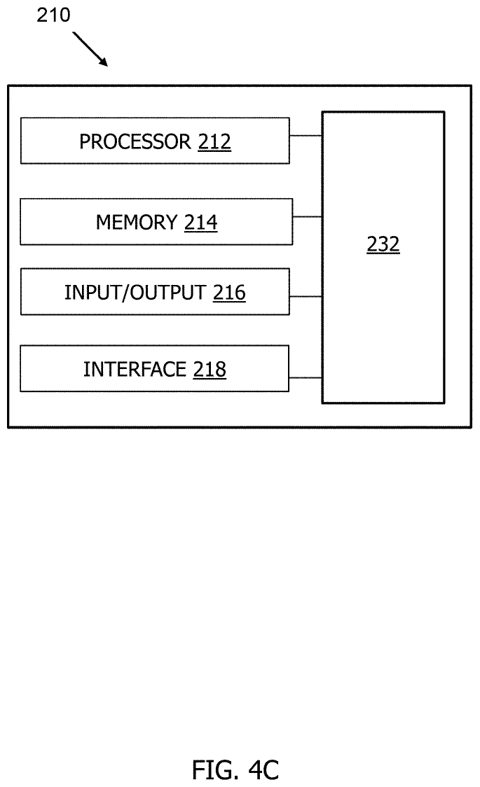

Referring now to FIGS. 4A-4C, there is shown another exemplary embodiment of a system 200 in accordance with the present disclosure. The system includes at least one server computing device 210, one or more user computing devices 220 in electronic communication with the server computing device 210, and one or more software applications 230 and 232 (FIGS. 4B and 4C) implemented across computing devices 210 and 220. The software applications 230 and 232 are configured to, when executed, access third party data sources 205. In the present disclosure, third party data sources 205 may include, but are not limited to, application programming interfaces (APIs) from one or more social media provider networks. Examples of social media provider networks include Instagram, TikTok, YouTube, LinkedIn, Twitter and Facebook. The user computing device 220 may be associated with a different person or user, such as a content creator or advertiser. Accordingly, the system 200 is configured to acquire, analyze, and update predetermined preferences for a) an advertiser or b) a social media content creator.

Software applications as described herein may be implemented over system components and configured to execute various steps in the methods described below. It should be appreciated that a software application can implement steps in the methods utilizing all of the system components or just portions of the system components. Furthermore, the software applications are described below in singular form. It should be appreciated that multiple software applications may interface to perform the described functions, and multiple applications can run on more than one computing devices to implement the methodologies described herein.

Continuing with reference to FIGS. 4A-4C, the system 200 is implemented via an exemplary architecture that includes computing devices 210 and 220 in electronic communication with each other via a common communications network, such as, for example the Internet. As illustrated, the user computing device 220 and server computing device 210 are arranged in a client-server architecture such that each user computing device may access data from a server computing device. “Access” or “accessing” as used herein can include retrieving information stored in memory on a computing device. For instance, “access” or “accessing” can include the server computing device 210 sending an instruction to computing device 220 to access information stored in the memory of the computing device 220. Reference to server computing device 210 and computing device 220 in this paragraph is exemplary and are used only to clarify use of words “access” or “accessing.”

FIG. 4A illustrates an exemplary client-server network in accordance with an embodiment of the present disclosure. However, the software application can be implemented over any number of network configurations such as the CPE architecture described above with reference to FIGS. 1-3. For example, in alternate embodiments, the computing devices are configured as a peer-to-peer network architecture. In still other alternative embodiments, the computing devices can be arranged in a ring-type network architecture. Further, the software application can be implemented across computing devices arranged on a network that includes aspects of a client-server network, peer-to-peer network, ring-type network, network utilizing CPE devices, and/or other network architectures known to a person of ordinary skill in the art. Accordingly, it should be appreciated that numerous suitable alternative communication architectures are envisioned.

Referring now to FIG. 4B, the computing device 220 is configured to receive, process, and store various information used to implement one or more software applications, such as client software application 230. The hardware components of computing device 220 can include any appropriate device, examples of which include a portable computing device, such as a laptop, tablet or smart phone, or other computing devices, such as a desktop computing device or a server-computing device.

As illustrated in FIG. 4B, the user computing device 220 includes one or more processors 222, a memory 224, an input/output 226, and a user interface (UI) 228. It is emphasized that the operation diagram depiction of the computing device 220 is exemplary and is not intended to imply a specific implementation and/or configuration. The processor 222, memory 224, input/output portion 226 and user interface 228 can be coupled together to allow communications therebetween and can interface with the software application 230. The software application 230 may include an application programming interface (API). As should be appreciated, any of the above components may be distributed across one or more separate computing devices.

Continuing with FIG. 4B, the memory 224 can be volatile (such as some types of RAM), non-volatile (such as ROM, flash memory, etc.), or a combination thereof, depending upon the exact configuration and type of processor 222. The computing device 220 can include additional storage (e.g., removable storage and/or non-removable storage) including, but not limited to, tape, flash memory, smart cards, CD-ROM, digital versatile disks (DVD) or other optical storage, magnetic cassettes, magnetic tape, magnetic storage or other magnetic storage devices, universal serial bus (USB) compatible memory, or any other medium which can be used to store information, and which can be accessed by the computing device 220.

Continuing with FIG. 4B, in various embodiments, the input/output portion 226 includes an antenna or an electronic connector for wired connection, or a combination thereof. In some implementations, input/output portion 226 can include a receiver and transmitter, transceiver or transmitter-receiver. The input/output portion 226 can receive and/or provide information pertaining to communication with a network such as, for example, the Internet. As should be appreciated, transmit and receive functionality may also be provided by one or more devices external to computing device 220, such as those described in FIGS. 1-3. For instance, the input/output portion 226 can be in electronic communication with a receiver.

Referring to FIG. 4B, the user interface 228 can include an input device and/or display (input device and display not shown) that allows a user to communicate with the computing device 220. The user interface 228 can include inputs that provide the ability to control the computing device 220, via, for example, buttons, soft keys, a mouse, voice actuated controls, a touch screen, movement of the computing device 220, visual cues (e.g., moving a hand in front of a camera on the computing device 220), or the like. The user interface 228 can provide outputs, including visual displays, such as exemplary display screens illustrated in FIG. 1. Other outputs can include audio information (e.g., via speaker), mechanically (e.g., via a vibrating mechanism), or a combination thereof. In various configurations, the user interface 228 can include a display, a touch screen, a keyboard, a mouse, an accelerometer, a motion detector, a speaker, a microphone, a camera, or any combination thereof. The user interface 228 can further include any suitable device for inputting biometric information, such as, for example, fingerprint information, retinal information, voice information, and/or facial characteristic information, for instance, to require specific biometric information for access to the computing device 220. It should be appreciated that the computer devices can operate via any suitable operating system, such as Android, BSD, iOS, Linux, OS X, QNX, Microsoft Windows, Windows Phone, and IBM z/OS. Furthermore, the software application can operate with any of the operating systems.

FIG. 4C is a diagram of the server computing device 210. The server computing device 210 includes one or more processors 212, a memory 214, an input/output 216, and an interface (UI) 218, and one or more software applications, such as a server application 232. The processor 212, memory 214, input/output portion 216 and interface 218 can be coupled together to allow communications therebetween. As should be appreciated, any of the above components may be distributed across one or more separate server computing devices. The server computing device processor 212, memory 214, input/output 216, and interface 218 are similar to the processors 222, memory 224, input/output 226, and interface 228 described above with respect to computing device 220. It should be appreciated that the server computing device can operate via any suitable operating system, such as Android, BSD, iOS, Linux, OS X, QNX, Microsoft Windows, Windows Phone, and IBM z/OS. It is emphasized that the operation diagram depiction of the server computing device 210 is exemplary and not intended to imply a specific implementation and/or configuration.

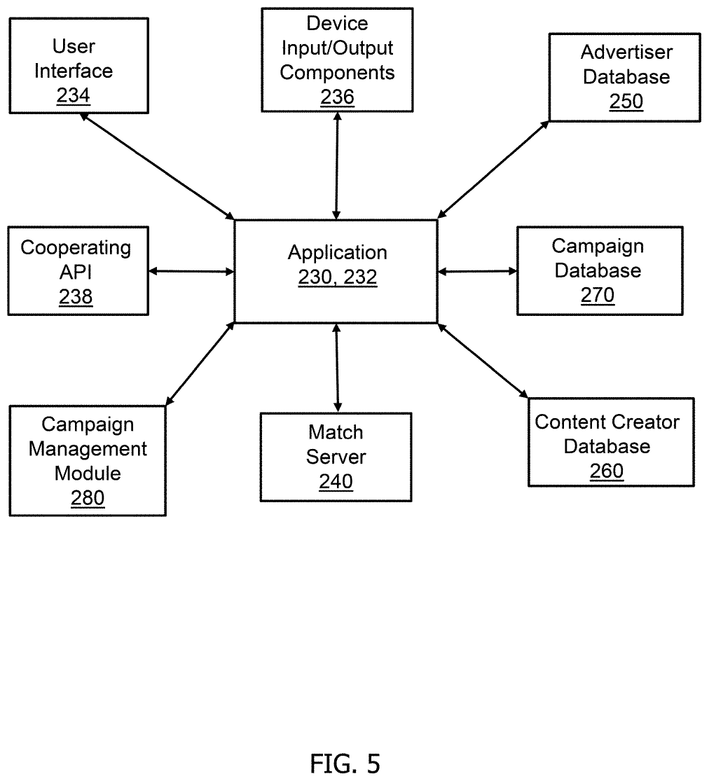

FIG. 5 is a schematic diagram illustrating various functional components of the software application 230, 232 implemented on one or more computing devices 210, 220. As illustrated, the software application 230, 232 includes several functional components, including, a user interface 234, device input/output components 236 (e.g., GPS, etc.), advertiser database 250, content creator database 260, cooperating 3^{rd} party application programming interfaces 238 and a match server 240. The software application 230, 232 also includes a campaign database 270 and a campaign management module 280. One or more of the functional components illustrated may be used to aid in the acquisition, development, and analysis of advertiser and content creator data for associating an advertiser and a content creator. For instance, user interface 234 guides the user (e.g., advertiser or content creator) through a series of inputs designed to compile advertiser preferences and user preferences. As discussed below, the user interface 234 can be used to receive inputs to facilitate associating an advertiser and a content creator. The advertiser database 250 stores a plurality of predetermined advertiser preferences and a plurality of advertiser attributes associated with a business profile of each advertiser campaign proposal. The content creator database 260 stores a plurality of predetermined user preferences and a plurality of user attributes associated with a social networking profile of each content creator. One or more of the functional components illustrated in FIG. 5 may be used to implement one or more aspects of the methods described herein on either or both user computing device 220 and server computing device 210. Accordingly, the software applications as described can comprise the software application 230 and the software application 232 such that certain functions may be implemented on the server computing device 210 and other functions may be implemented on the user computing device 220. Accordingly, for descriptive purposes, it is to be understood that the software application 230 and software application 232 may be used interchangeably in the present disclosure.

FIG. 5 illustrates an exemplary software application for associating an advertiser and a content creator. The software application 232 may be implemented primarily on the server computing device 210. However, certain functions may be implemented on a user computing device 220, as described above. The software application 232 may access the plurality of predetermined user preferences and the plurality of user attributes from the content creator database 260. The software application 232 may also access the plurality of predetermined advertiser preferences and the plurality of advertiser attributes from the advertiser database 250.

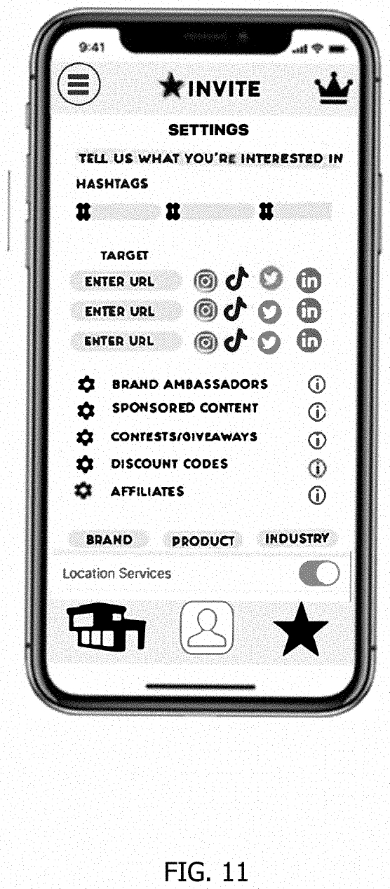

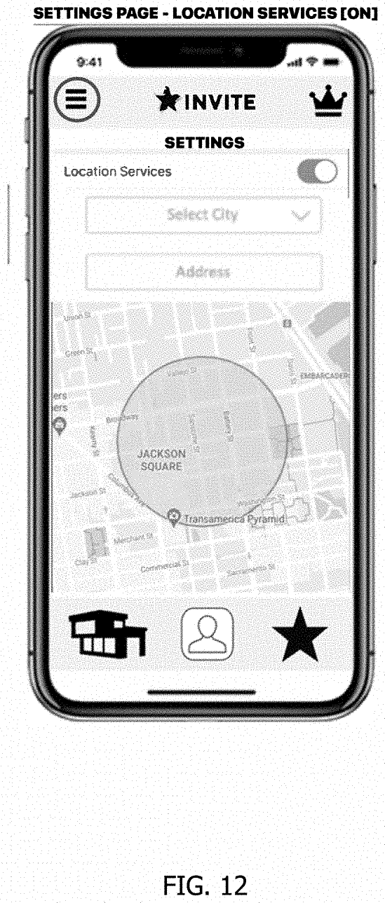

The predetermined user preferences can include data such as hashtags, target URL or website addresses, roles, brands of interest, products, industry and location services. In FIG. 11, there is shown an example graphical user interface wherein an advertiser and content creator can identify predetermined preferences. The hashtags can be used to collect words of interest for a clustering algorithm that will facilitate the determination of similarity between a content creator and advertiser. Target URLs are used to identify brands of interest for a content creator. Roles identify the type of job descriptions available for a content creator. In general, the brand, product and industry can be associated with inputs for allowing a content creator to provide more insight regarding predetermined user preferences for an advertiser campaign. As shown in FIG. 12, a location-based preference may be incorporated as one of the predetermined user preferences. A content creator can identify a geographic location of interest for advertiser campaigns they want to work on. It is to be further contemplated that this location input can be received via the device input/output components 236.

The plurality of user attributes can include information retrieved from a social media profile of the content creator such as number of followers, location, engagement rate and number of posts. It is to be understood that the user attributes can develop over time to include other information related to the social media profile of the content creator. In accordance with an aspect, the user attributes can also be retrieved via cooperating 3^{rd} party application programming interfaces 238 from social media platforms associated with the content creator.

Collectively, the predetermined user preferences and the plurality of user attributes are used to generate a user preference profile that facilitates the process of associating an advertiser with a content creator. The user preference profile is intended to identify particular qualities and characteristics of a content creator that help determine if the content creator is suitable for an advertiser campaign proposal. It is to be understood that the user preference profile is subject to change and will constantly evolve as the content creator's presence and profile changes on social media platforms. It is to be further understood that the user preference profile will continually be updated in real time based on information received from the 3^{rd} party application programming interfaces 238 for example. As further discussed below, the user preference profile correlates to a generated value, a quantitative parameter used to match i.e., associate an advertiser and a content creator.

Similar to the predetermined user preferences, the predetermined advertiser preferences can include data such as hashtags, target URL or website addresses, roles, brands of interest, products, industry and location services. Referring to FIG. 11, there is shown an example graphical user interface wherein an advertiser and content creator can identify predetermined preferences. The hashtags can be used to collect words of interest for a clustering algorithm that will facilitate the determination of similarity between a content creator and advertiser. Target URLs are used to identify similar brands of interest for an advertiser campaign. Roles identify the type of job descriptions offered by the advertiser for an advertiser campaign. In general, the brand, product and industry can be associated with inputs for allowing an advertiser to provide more insight regarding predetermined advertiser preferences tailored to its advertiser campaign. As shown in FIG. 12, a location-based preference may be incorporated as one of the predetermined advertiser preferences. An advertiser can identify a geographic location of interest for content creators they want to work with. It is to be further contemplated that this location input can be received via the device input/output components 236.

The plurality of advertiser attributes can include information retrieved from a business profile of the advertiser associated with the advertiser campaign. Such information can include number of followers for a brand, location, engagement rate and number of posts. It is to be understood that the advertiser attributes can develop over time to include other information related to the business profile of the advertiser. In accordance with an aspect, the advertiser attributes can also be retrieved via cooperating 3^{rd} party application programming interfaces 238 from social media platforms associated with the advertiser.

Collectively, the predetermined advertiser preferences and the plurality of advertiser attributes are used to generate an advertiser preference profile that facilitates the process of associating an advertiser with a content creator. The advertiser preference profile is intended to identify the desired qualities and characteristics an advertiser is looking for in advertising or promoting specific products or services associated with the advertiser preference profile. It is to be understood that the advertiser preference profile is subject to change and will constantly evolve based on the changing needs of an advertiser as it seeks to launch new products and services representing its brand. It is to be further understood that the advertiser preference profile will continually be updated in real time based on information received from the 3^{rd} party application programming interfaces 238 for example. As further discussed below, the advertiser preference profile correlates to a desired value, a quantitative parameter used to match i.e., associate an advertiser and a content creator.

It should be appreciated that the predetermined advertiser preferences, advertiser attributes, the predetermined user preferences, and user attributes could be applied to any product or service that is the subject of an advertiser campaign proposal. As further discussed below, the software application uses these attributes and preferences of advertisers and content creators to associate the advertiser with a specific content creator based on a match score, as further described herein.

In accordance with an aspect, the cooperating 3^{rd} party application programming interfaces 238 may include social media platforms such as Instagram, TikTok, YouTube, Linkedln, Twitter and Facebook. It is to be understood that additional application programming interfaces that provide information about the advertiser or the content creator may be utilized to improve the function of the software application 230, 232.

In accordance with an aspect, the user interface 234 can be utilized to collect data on the user preferences or the advertiser preferences. As further discussed below, after content creators are associated with advertisers, the user interface is utilized to display matches to content creators and advertisers. Upon determining a mutual match, the content creator and advertiser are subsequently introduced by the software application.

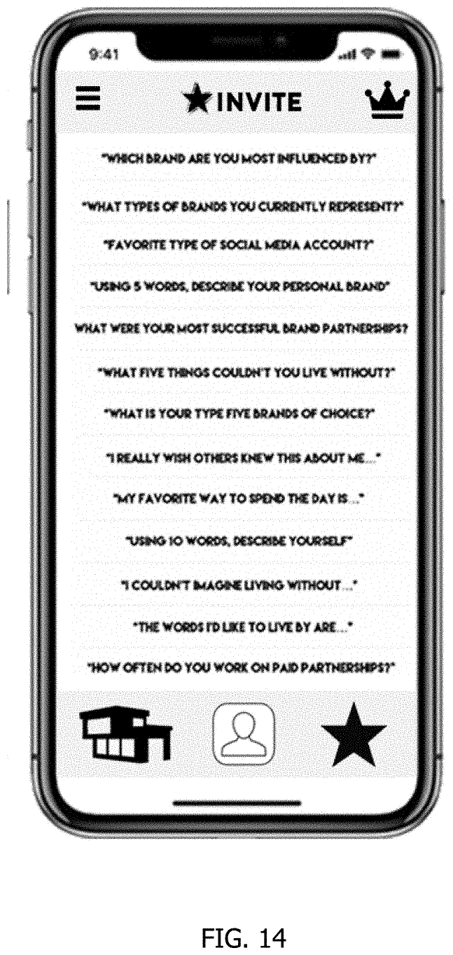

The match server 240 is used to associate a content creator with an advertiser based on the user preference profile, the advertiser preference profile, a content creator score associated with the content creator, and an advertiser score associated with the advertiser of the one or more advertiser campaign proposals. In one or more scenarios, techniques may include, for example receiving additional preference inputs from users via the user interface 234. For example, as shown in FIG. 14, the content creator can provide responses to a plurality of questions on the user interface 234, wherein the responses can facilitate associating the content creator with the advertiser. Specifically, responses to the question prompts can be used to determine accurate matches via a clustering algorithm in the match server 240.

In addition, as shown in FIG. 12, the advertiser or content creator can seek an advertiser or content creator in a specific geographic location. Based on the process and methods described herein, an advertiser and content creator are associated based on predictive intelligence resulting in a match value. As further discussed below, upon confirmation of a mutual match, the software application to be utilized by the advertiser and content creator to direct campaign management activities with the content creator and facilitate direct payment account management.

It is to be understood that advertiser inputs may be used in addition to performance data, for categories to be clustered with community size to community engagement to predict behavior with distributions and correlations. For example, this includes clustering small sets of preference data that are presumed to have the similar value of an attribute (e.g., a mean) and using the combined larger set to obtain a precise estimate of that characteristic using methods such as a least linear square regression.

In one or more scenarios, the match server 240 may use one or more, or a plurality, of servers and equipment, where one or more, or each device may perform one or more functions to receive and communicate information between systems.

In accordance with an aspect, it is foreseeable that the match server 240 may include machine learning algorithms to predict a content creator's credibility. The system may allow advertisers a full assessment of a content creator. For example, the match server can utilize Artificial Intelligence (AI), Machine Learning (ML), and Natural Language Processing (NLP) to analyze the content of a content creator's social media profile and automatically generate insights on interests, industries, demographics, and brand affinities from them.

Similarly, it may also assess the content and measure of the sentiment of comments (and the posts of the commenters) to draw inferences about the content creator's rate of engagement and audience. Based on an advertiser campaign, past content creator marketing efforts, and provided inputs, the software application associates content creators that would be most successful for advertiser campaigns. Updating the match server to account for such variables reduces time and effort associated with content creator marketing workflow, especially when working with new advertisers and new content creators.

In operation, the content creator database and the advertiser database can be configured to extract user and advertiser attributes from 3^{rd} party data sources for use with the matching server 240. In accordance with an aspect, the advertiser database and content creator database each can further include an attribute extraction application that, when executed, retrieves the advertiser attributes and user attributes data. The extraction applications are configured to access third party data sources such as the 3^{rd} party application programming interfaces 238 described above. For example, the extraction applications can access, via communications network, a first web accessible social media profile, a second web accessible social media profile and a third web accessible social media profile. While three social media profiles are discussed, the extraction applications can be configured to extract advertiser attributes and user attributes data from many more sources than just three. It is to be understood that information retrieved from the content creator database and advertiser database is supplied to the match server 240 for associating an advertiser and a content creator.

Embodiments of the present disclosure also allow for assigning weighted values to the various user attributes, advertiser attributes, predetermined advertiser preferences, and predetermined user preferences. Allowing a content creator to weight, e.g., prioritize predetermined user preferences and allowing an advertiser to weight, e.g., prioritize predetermined advertiser preferences allows the match server 240 to more accurately match an advertiser and a content creator.

As further discussed below, the campaign database 270 can store data associated with previous advertiser campaigns, influence of social media content creators and return on investment of previous advertiser campaigns. The campaign database 270 can also be used to store terms of previous term sheets or smart contracts that were executed by an advertiser and content creator with a previous advertiser campaign. These stored terms can help facilitate generating campaign offers for new advertiser campaign proposals.

The campaign management module 280 can be used in real time by an advertiser and content creator to establish and measure campaign performance obligations, coordination of posting guidelines, interaction data with followers, transaction data, measuring influence of the advertiser campaign in real time, pricing of the campaign, and pricing/payment based on outcomes of the advertiser campaign.

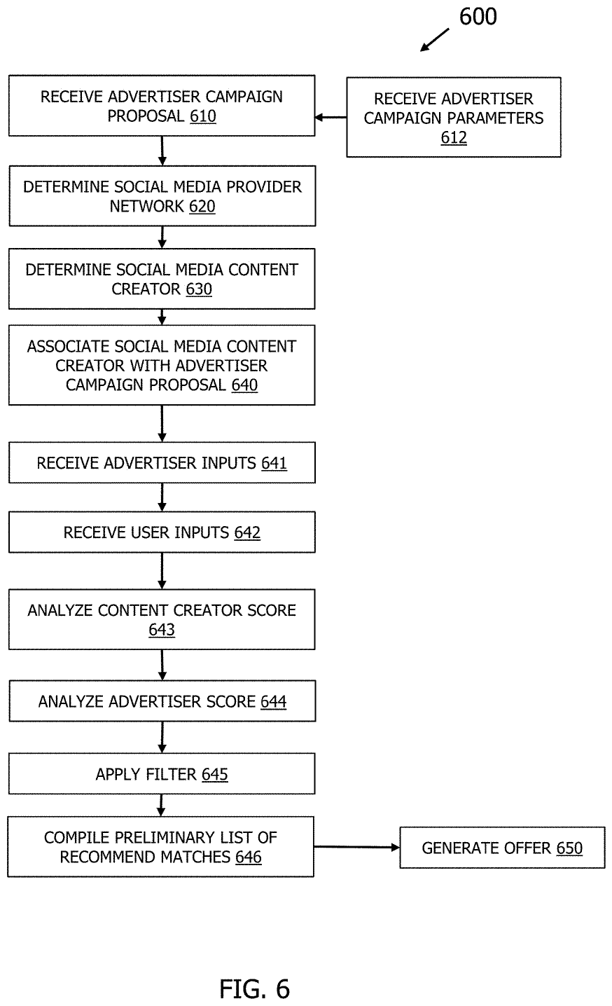

As shown in FIG. 6, embodiments of the present disclosure include a process 600 for associating a content creator with an advertiser associated with one or more advertiser campaign proposals. The process 600 is exemplary and focuses on advertisers looking for a content creator for one or more advertiser campaign proposals. Specifically, the process 600 is a method performed by at least one control device in communication with a communications network. The process begins in block 610 when the control device receives one or more advertiser campaign proposals via the communications network. As shown in block 612, the step of receiving one or more advertiser campaign proposals further includes receiving inputs indicative of a plurality of predetermined campaign parameters. For example, the predetermined campaign parameters may include a particular social media platform, a content creator follower size, her/his engagement rate, her/his audience demographic, etc. It is to be understood that the predetermined campaign parameters may include other factors not identified that relate to the brand or product that is the subject of the one or more advertiser campaign proposals.

In block 620, the control device determines one or more social media provider networks that are adapted for at least one of the one or more advertiser campaign proposals. In other words, a particular social media provider network is identified based on the predetermined campaign parameters such as the desired social media platform that an advertiser wants to use for promotion and advertising of their product or brand.

In block 630, the control device identifies at least one social media content creator associated with at least one of the one or more social media provider networks identified in block 620. That is, the control device is configured to determine a list of social media content creators that are associated with the chosen social media provider networks.

In block 640, the control device is configured to associate the at least one social media content creator with a producer of at least one of the one or more advertiser campaign proposals received in block 610. As shown in blocks 641-646, the step of associating, by the control device, the at least one social media content creator with the producer of at least one of the one or more advertiser campaign proposals includes additional steps. Block 641 includes receiving advertiser inputs indicative of a plurality of predetermined advertiser preferences associated with the one or more advertiser campaign proposals. Block 642 includes receiving user inputs indicative of a plurality of predetermined user preferences of the at least one social media content creator. In block 643, the step includes analyzing a content creator score associated with a social networking profile of the at least one social media content creator. Similarly, in block 644, the step includes analyzing an advertiser score associated with a business profile of the one or more advertiser campaign proposals and their respective advertisers.

In block 645, a filter is applied to the list of at least one social media content creator identified from the at least one or more social media provider networks. Specifically, the filter is based on the predetermined advertiser preferences of the one or more advertiser campaign proposals, the predetermined user preferences of the at least one social media content creator, the content creator score associated with the social networking profile of the at least one social media content creator, and the advertiser score associated with the business profile of the one or more advertiser campaign proposals and their respective advertisers. As shown in block 646, based on the filter, a preliminary list of recommended matches is compiled, wherein the preliminary list of recommend matches includes a match value associated with each of the at least one social media content creators. The match value is indicative of the strength of a match or association between the advertiser of the advertiser campaign proposal and the social media content creator.

It is to be understood that the content creator score and the advertiser score are updated in real time based on a plurality of indicators associated with a measure of reputation of the social media content creator and the advertiser associated with the advertiser campaign proposal. For example, the content creator score is based on performance obligations of previous advertiser campaign proposals that a content creator has performed. The performance obligations include timeliness, whether a content creator meets deadlines, and their responsiveness to communications regarding an advertiser campaign proposal. Similarly, the advertiser score is based on previous advertiser campaign proposals that the advertiser has collaborated on with other content creators. That is, the advertiser score can be based on the performance of previous advertiser campaigns, their responsiveness to communications and their timeliness. While the plurality of indicators are described above with respect to the content creator score and advertiser score, it is to be further understood that the plurality of indicators can include other indicators associated with a measure of reputation of the social media content creator and the advertiser.

In block 650, the method further includes the step of the control device generating a campaign offer based on criteria stored on the campaign database. The criteria can include data associated with previous advertiser campaigns, engagement rate of the social media content creator and the return on investment of previous advertiser campaigns. It is to be understood that the campaign offer can be generated based on any other criteria indicative of the potential success and/or measured success of previous advertiser campaigns.

Alternatively, the process 600 can further include the step of communicating, by the control device, with the Internet via the communications network.

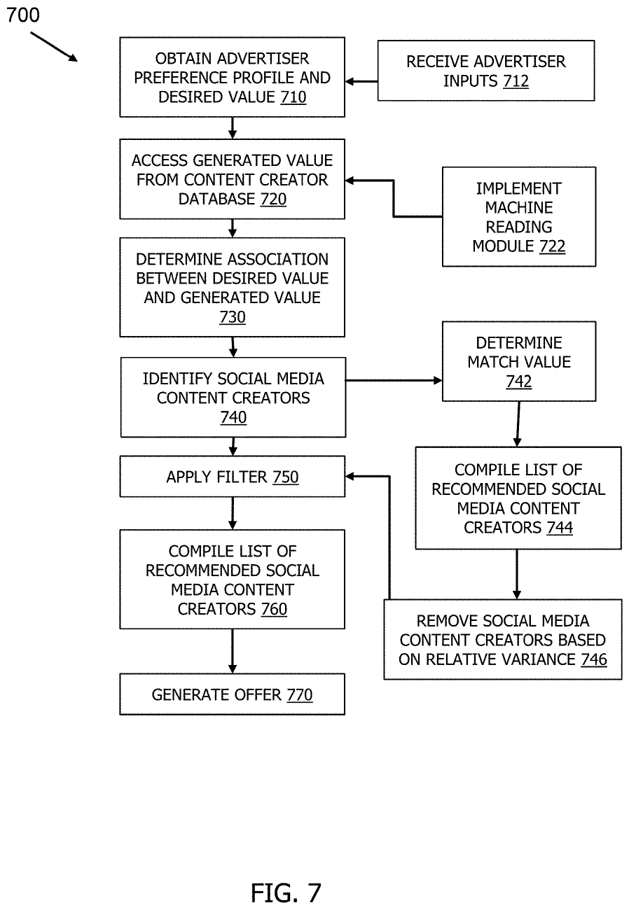

As shown in FIG. 7, another embodiment of the present disclosure includes a process 700 for associating a content creator with an advertiser associated with one or more advertiser campaign proposals. The process 700 begins in block 710 wherein an advertiser preference profile for social media content creators is obtained with a software application running on one or more computing devices. The advertiser preference profile includes a desired value of one or more attributes associated with social media content creators. As shown in block 712, the step of obtaining the advertiser preference profile further includes receiving inputs based on the one or more attributes associated with social media content creators. For example, the one or more attributes may include a content creator follower size, his/her engagement rate, his/her location, or number of posts. It is to be understood that the one or more attributes may include other factors not identified that relate to a social media content creator or brand that is the subject of the advertiser campaign proposal.

In block 720, the method includes the step of accessing a database of social media content creators, wherein the database includes a generated value corresponding to each social media content creator. The generated value corresponds to the one or more attributes associated with social media content creators. As shown in block 722, the method can include implementing a machine reading module to extract one or more attributes associated with social media content creators based on a social networking profile of the social media content creator.

In block 730, the method includes determining an association between the desired value and the generated value corresponding to at least one of the social media content creators. Based on the association identified in block 730, block 740 includes the step of identifying one or more social media content creators from a plurality of social media content creators obtained from the content creator database. As shown in block 742, the step of identifying one or more social media content creators from the plurality of social media content creators obtained from the database further includes determining a match value for each of the one or more social media content creators. The match value is based on a relative variance between the advertiser preference profile and the attributes of each of the social media content creators in the database.

For instance, the relative variance is a quantitative parameter indicative of a difference between the desired value of the advertiser preference profile and the generated value of the social media content creator. The quantitative parameter is a sum of an absolute value of the difference between the desired value of the advertiser preference profile and the generated value of the social media content creator. As shown in block 744, the method further includes the step of compiling a list of recommended social media content creators wherein the relative variance between the desired value of the advertiser preference profile and the generated value of the social media content creator is within a predetermined threshold. Subsequently, as shown in block 746, there is a step of removing social media content creators from the list of recommended social media content creators where the relative variance between the desired value of the advertiser preference profile and the generated value of the social media content creator is outside of the predetermined threshold.

In block 750, a filter is applied to the one or more social media content creators identified from the database, based on a content creator score associated with a social networking profile of the at least one social media content creator. As shown in block 760, based on the filter, a preliminary list of recommended social media content creators is compiled, wherein the preliminary list of social media content creators includes at least one or more social media content creators obtained from the database. It is to be understood that the predetermined threshold and the requirements of the content creator score can be adjusted to further select additional social media content creators for the preliminary list of recommended social media content creators up to a predetermined amount.

It is to be further understood that the content creator score and an advertiser score are updated in real time based on a plurality of indicators associated with a measure of reputation of the social media content creator and an advertiser associated with the advertiser campaign proposal. For example, the content creator score is based on performance obligations of previous advertiser campaigns that a content creator has performed. The performance obligations include timeliness, whether a content creator meets deadlines, and their responsiveness to communications regarding an advertiser campaign. Similarly, the advertiser score is based on previous advertiser campaigns that the advertiser has collaborated on with other content creators. That is, the advertiser score can be based on the performance of previous advertiser campaigns, their responsiveness to communications and their timeliness. While the plurality of indicators are described above with respect to the content creator score and advertiser score, it is to be further understood that the plurality of indicators can include other indicators associated with a measure of reputation of the social media content creator and the advertiser.

In block 770, the method includes generating a campaign offer based on criteria stored on the campaign database. The criteria can include data associated with previous advertiser campaigns, engagement rate of the social media content creator and the return on investment of previous advertiser campaigns. However, it is to be understood that the campaign offer can be generated based on any other criteria indicative of the potential success and/or measured success of previous advertiser campaigns.

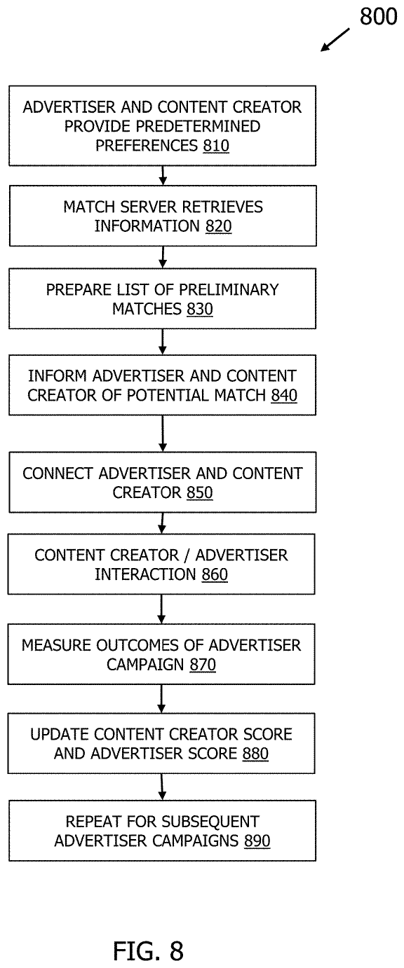

FIG. 8 is a simplified process flow diagram illustrating an exemplary method for associating advertisers and content creators according to an embodiment of the present disclosure. The process begins in block 810 when the advertiser and the content creator provide predetermined preferences. As previously discussed, the predetermined preferences can be weighted to favor certain preferences over others.

In block 820, the match server 240 and/or software application 230, 232 retrieves information from the content creator database and the advertiser database including, but not limited to, the advertiser preference profile, user preference profile, content creator score, and advertiser score.

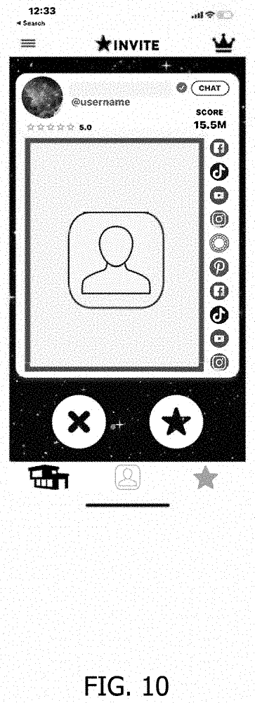

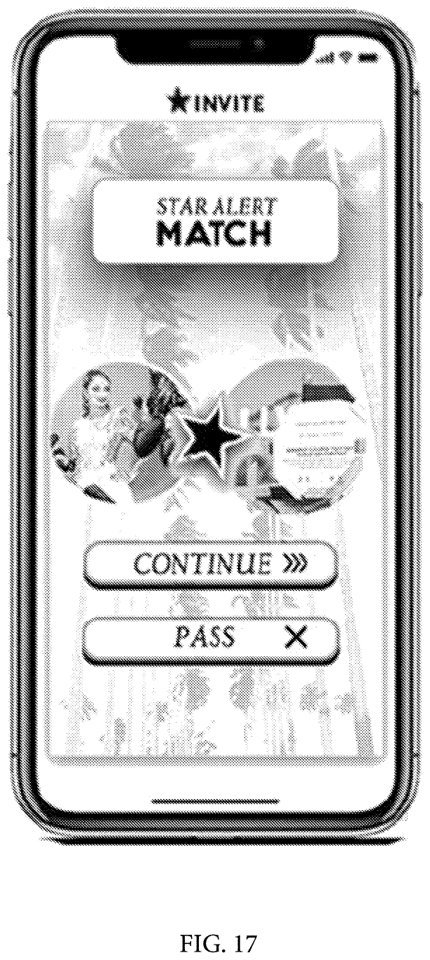

Thereafter, in block 830 the match server prepares a list of preliminary matches along with match values indicating the strength of match between the advertiser of the advertiser campaign proposal and each content creator. In block 840, the match server informs the advertiser and the content creator of a potential match when their match value is above a predetermined threshold value. That is, the advertiser and content creator are each provided with an opportunity to indicate a mutual interest. For example, as shown in FIG. 10, the advertiser and content creator can use a swipe feature to indicate a mutual interest. Thereafter, in block 850, if the advertiser and the content creator both provide affirmative responses to a potential match, the advertiser and the content creator are introduced i.e., directly connected to one another. For example, as shown in FIG. 17, the advertiser and the content creator are provided with an opportunity to connect after using the swipe feature to indicate a mutual interest.

In block 860, the advertiser and the content creator can directly chat, negotiate terms of an advertiser campaign, coordinate payment and revenue associated with the advertiser campaign, and utilize the campaign management module to execute the advertiser campaign. Thereafter, in block 870, the outcomes of the completed advertiser campaign are measured including performance, return on investment and responsiveness.

In block 880, the content creator score stored in the content creator database and the advertiser score stored in the advertiser database is updated to reflect the outcomes of the completed advertiser campaign measured in block 870. In accordance with an aspect, the contract terms of the advertiser campaign can be stored in the campaign database for use with future advertiser campaign proposals.

As shown in block 890, this process is repeated with subsequent advertiser campaigns between advertisers and content creators to reflect updates in their content creator score and advertiser score over time based on the success of completed advertiser campaigns.

Exemplary methods of the present disclosure described above generally identify use of the system for associating advertisers and content creators. As described above, the system comprises the content creator database 260 of one or more social media content creators, the advertiser database 250 of one or more advertiser campaign proposals, and the software application 230, 232. The one or more social media content creators each include the plurality of predetermined user preferences and the plurality of user attributes associated with a social networking profile of each social media content creator. The one or more advertiser campaign proposals each include the plurality of predetermined advertised preferences and the plurality of advertiser attributes associated with a business profile of each advertiser campaign proposal. The software application 230, 232 is configured to obtain the user preference profile for social media content creators and the advertiser preference profile for advertiser campaign proposals. The user preference profile and the advertiser preference profile are used to determine an association between the advertiser associated with the advertiser campaign proposal and the one or more social media content creators obtained from the content creator database.

The software application 230, 232 is further configured to determine a match value for each of the plurality of social media content creators obtained from the content creator database 260. The match value is based on a relative variance between the advertiser preference profile and the user preference profile of the social media content creators. The relative variance is a quantitative parameter indicative of a difference between a desired value corresponding to the advertiser preference profile and a generated value corresponding to the user preference profile of the social media content creator. In other words, the quantitative parameter is a sum of an absolute value of the difference between the desired value of the advertiser preference profile and the generated value of the social media content creator. The software application is configured to compile a list of recommended social media content creators where the relative variance between the desired value and the generated value is within a predetermined threshold. Alternatively, the software application can be configured to compile a list of recommended social media content creators based on the match value.

In accordance with another aspect of exemplary embodiments discussed above, the system for associating advertisers and content creators further includes the graphical user interface, i.e., user interface 234. Specifically, the graphical user interface 234 is configured to display the list of recommended social media content creators to a producer associated with the one or more advertiser campaign proposals. Similarly, the graphical user interface is configured to display a campaign offer list of advertiser campaign proposals to a social media content creator identified in the list of recommended social media content creators. That is, the producer and the social media content creator are each provided with a list of potential matches based on the relative variance and match value scores described above.

The graphical user interface 234 is then configured to receive inputs indicative of a selection by the social media content creator and receive inputs indicative of a selection by the producer associated with the advertiser campaign proposal. The software application 230, 232 is then configured to compare the received inputs from the social media content creator with the received inputs from the producer of the advertiser campaign proposal. Based on a comparison, the software application is configured to identify a preliminary match between the social media content creator and the producer of the advertiser campaign proposal. Thereafter, the graphical user interface 234 is configured to establish an interaction, e.g., introduction between the social media content creator and the producer of the advertiser campaign proposal if they identify each other as a match. FIGS. 10 and 17 illustrate example graphical user interfaces wherein the advertiser and content creator are prompted to associate (FIG. 10) or are already associated with one another (FIG. 17). For example, as shown in FIG. 10, the advertiser and content creator can use a swipe feature to indicate a mutual interest. Additionally, the content creator or advertiser profiles are linked to social media platforms. As shown in FIG. 17, both the content creator and the advertiser have indicated a mutual match using the swipe feature, thereby triggering a prompt on the graphical user interface 234 to open the opportunity for collaboration on an advertiser campaign.

It is to be understood that the software application can be further configured to filter the list of recommended social media content creators based on a content creator score associated with the social media content creator and an advertiser score associated with an advertiser of the advertiser campaign proposal. As previously discussed, the content creator score and the advertiser score are updated in real time based on a plurality of indicators associated with a measure of reputation of the social media content creator and the advertiser.

The software application is further configured to generate a campaign offer based on criteria retrieved from the campaign database 270. The criteria can include data associated with previous advertiser campaigns, engagement rate of the social media content creator and the return on investment of previous advertiser campaigns.

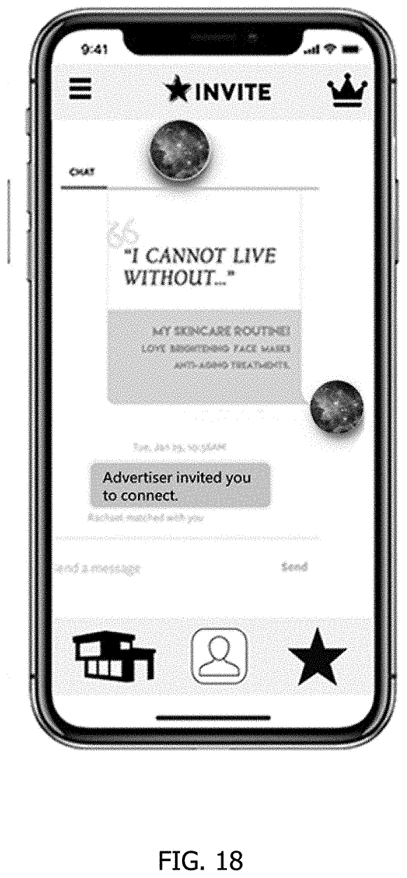

Upon establishing an introduction between an associated advertiser and a social media content creator, the advertiser and the social media content creator can directly interact with one another through a push messaging component where the advertiser and social media content creator can directly chat with one another to establish and finalize contract terms of an advertiser campaign. FIG. 18 illustrates an example graphical user interface wherein an advertiser and content creator directly chat using a push messaging component.

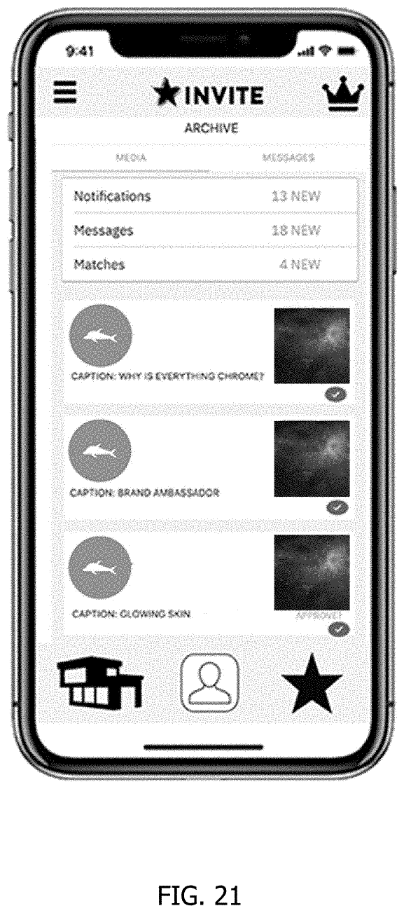

In accordance with an aspect of the exemplary embodiment, the system further includes the campaign management module 280 (FIG. 5) that allows for the advertiser and the content creator to coordinate and execute an advertiser campaign. For example, the campaign management module 280 can be used to establish and measure campaign performance obligations, coordination of posting guidelines, interaction data with followers, transaction data, measuring influence of the advertiser campaign in real time, pricing of the advertiser campaign, and pricing/payment based on outcomes of the advertiser campaign. FIG. 21 illustrates an example graphical user interface depicting communications and obligations between an advertiser and content creator for coordinating an advertiser campaign. The archive page depicted in FIG. 21 can be used to coordinate approval of pre-uploaded posts, messages, and comments based on the parameters associated with a smart contract associated with the advertiser campaign. It is to be understood that the archive page can facilitate private communications between the advertiser and the content creator when coordinating execution of the advertiser campaign. For example, the advertiser will have the ability to review and approve of media before a content creator goes live (e.g., proper disclosure, caption, tags, etc.).

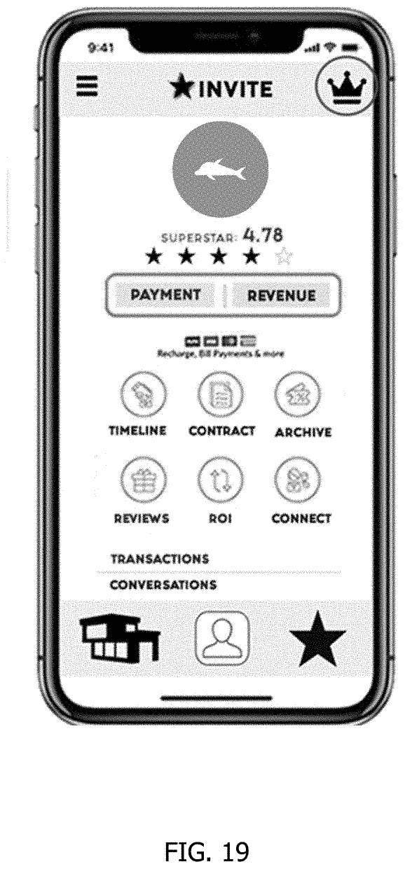

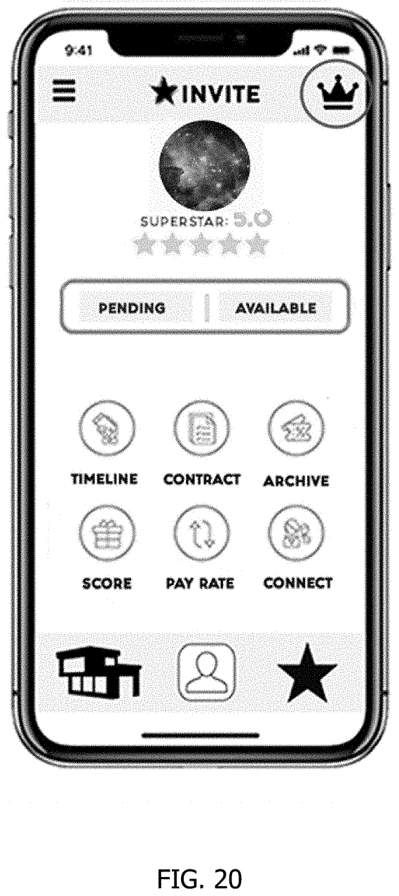

As shown in FIGS. 19 and 20, the advertiser and content creator can review and access real time information related to ongoing advertiser campaigns and completed advertiser campaigns. Specifically, FIG. 19 illustrates an example graphical user interface depicting advertiser campaigns associated with an advertiser. The advertiser campaign page discloses payment and revenue of advertiser campaigns. Payment refers to the amount paid to content creators for a particular advertiser campaign and revenue refers to the amount generated from the particular advertiser campaign. As shown in FIG. 19, there are also links to timelines, contracts, archives, reviews, return on investment, and connections/followers. The advertiser can also access conversations and transactions associated with the particular advertiser campaign. Similarly, FIG. 20 illustrates an example graphical user interface depicting advertiser campaigns associated with a content creator. The content creator campaign page discloses pending charges for active advertiser campaigns as well as available funds generated from completed advertiser campaigns. As shown in FIG. 20, there are also links to timelines, contracts, archives, reviews, compensation rate, and connections/followers. The content creator can also access conversations and transactions associated with the particular advertiser campaign. The content creators and advertisers will have real-time insights on driving revenue forces, clicks-per-second, likes/followers' engagement on post, as factors in calculating return on investment.

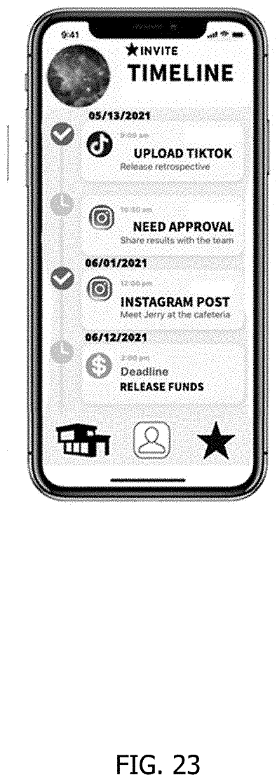

FIG. 23 illustrates an example graphical user interface identifying obligations on a timeline for a content creator in an advertiser campaign to facilitate proper execution of the advertiser campaign. As shown in FIG. 23, the timeline can outline campaign performance obligations on specific dates based on inputs associated with a smart contract associated with the advertiser campaign. For example, inputs may include total posts for an advertiser campaign, timing of posts on a social networking profile, and lead time required for advertiser approval of an advertiser campaign related post.

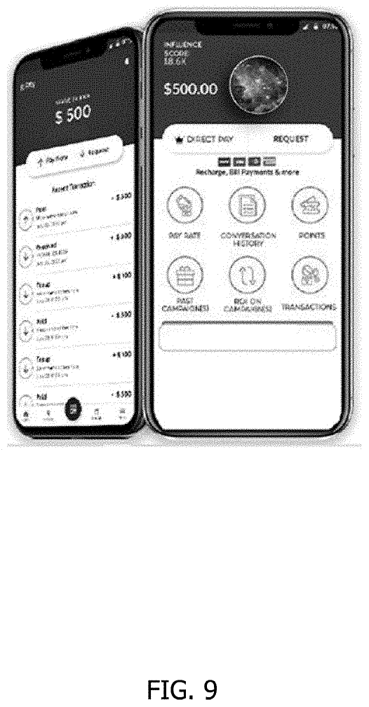

Following the execution of an advertiser campaign between an advertiser and content creator, the direct connection between the advertiser and the content creator facilitates efficient financial transactions between the advertiser and the content creator. For example, transactions can include payment and revenue of advertiser campaigns including incremental payments to a content creator based on meeting performance obligations or benchmarks of the advertiser campaign. This can further include pending and completed charges associated with carrying out the advertiser campaign. FIG. 9 illustrates an example graphical user interface wherein an advertiser and content creator utilize a direct payment method in connection with an advertiser campaign.

Advertisers and content creators can agree on a variety of different compensation structures. For example, ‘pay per post’ (PPP) agreements allow advertisers to pay content creators a ‘fixed-rate’ fee for a single post or a series of posts. Another payment method of a content creator includes ‘pay per campaign’ (PPC), through a flat advertiser campaign fee. Pay per click (PPC), or cost per click (CPC), models are when a content creator is paid each time a user/follower “clicks” on a link specified by the brand. Pay-per-acquisition, (PPA) or often referred to as cost-per-acquisition (CPA), allows advertisers to render payment when a content creator's efforts result in a new customer often through an affiliate link. The term “customer” can be defined as an individual who purchases a product or service, downloads an application, signs up for a newsletter, or takes some other type of action meaningful to an advertiser. Within each platform, however, more popular and effective content creators will generally receive a higher fee for their services. It is to be understood that any compensation structure suitable for the intended purpose of compensating a content creator may be utilized in connection with the present disclosure.

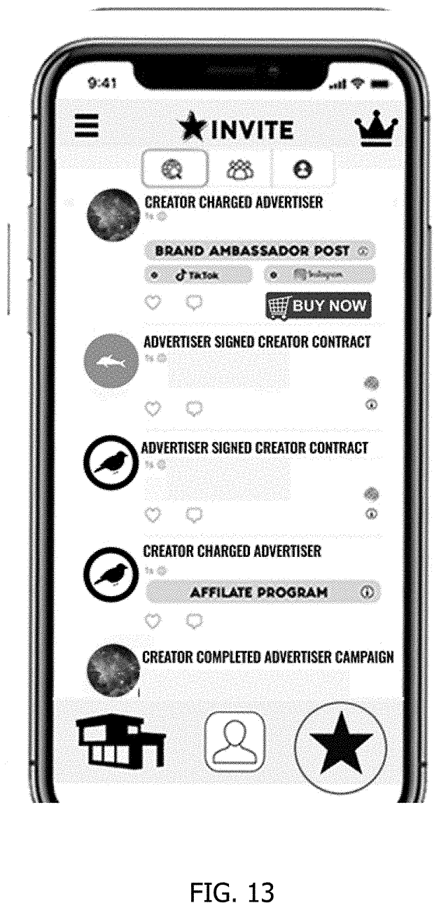

In accordance with an aspect, the campaign management module allows for a transparent system that discloses advertiser campaigns occurring on the software application. For example, it is to be understood that the advertiser and content creator can optionally showcase the progress publicly or privately with followers. FIG. 13 illustrates an example graphical user interface for viewing activities of a content creator and an advertiser for an advertiser campaign on a newsfeed. It is to be further understood that the newsfeed may be utilized to disclose certain aspects of the advertiser campaign based on advertiser and/or content creator preference.

It is to be understood that the campaign management module can be used to provide insight into key performance indicators resulting from the delivery of optimized content by a content creator. The insights may include identifying optimized content that yields maximum returns. Through this real time ability to manage the advertiser campaign and utilize previously completed advertiser campaigns, advertisers can gain recommendations on content creators and social media platforms to maximize their return on marketing investment. This data can continually be updated and stored in the campaign database and to further develop the value of the content creator database and the advertiser database.

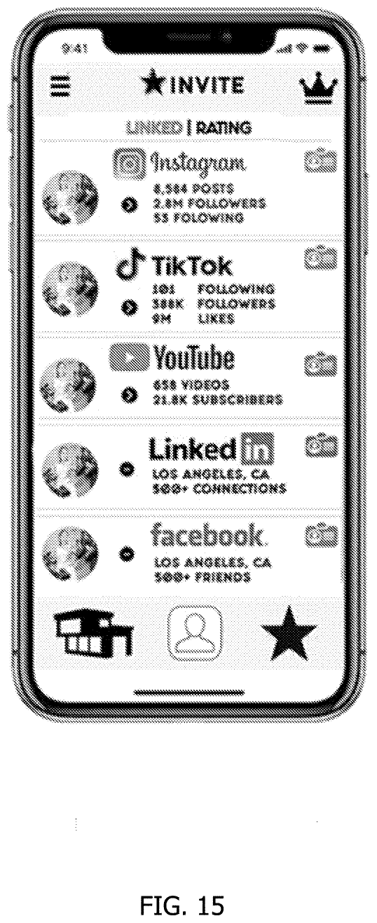

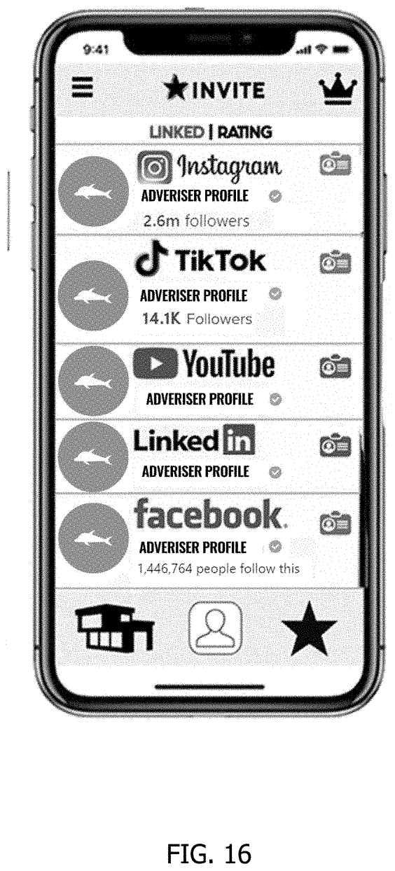

In accordance with another aspect, the software application allows for a content creator and advertiser to link all of their associated social media provider networks. FIG. 15 illustrates an example graphical user interface for a content creator that identifies social media provider networks linked with the content creator. Similarly, FIG. 16 illustrates an example graphical user interface for an advertiser that identifies social media provider networks linked with the advertiser.

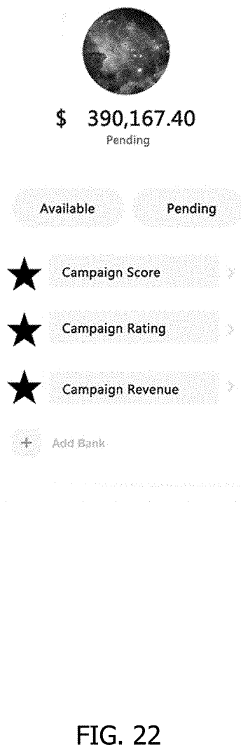

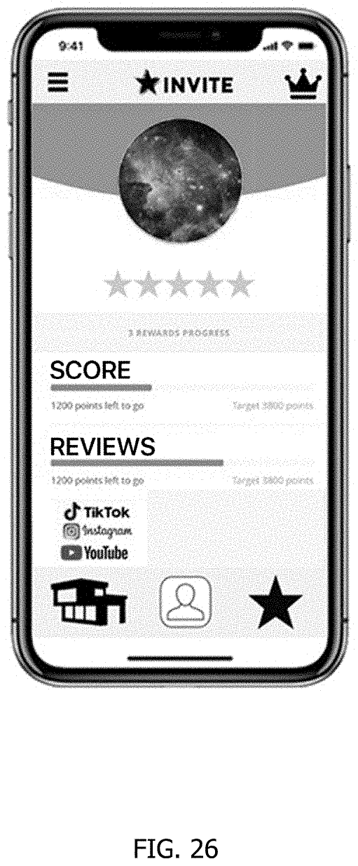

After completion of the advertiser campaign, an outcome analysis of the success of the advertiser campaign is conducted. The outcome analysis includes factors such as, but not limited to, measuring performance and return on investment. FIG. 22 illustrates an example graphical user interface identifying outcomes associated with a completed advertiser campaign. The outcomes can include, but are not limited to, advertiser campaign score, rating, and revenue. Additionally, the advertiser and the content creator provide feedback and a rating for one another based on their experience in the advertiser campaign. The rating is used to update and aggregate the content creator score and advertiser score associated with each user. That is, the rating for the content creator is used to update the content creator score stored in the content creator database for the social media content creator. Similarly, the rating for the advertiser is used to update the advertiser score stored in the advertiser database for advertisers associated with advertiser campaigns. FIG. 26 illustrates an example graphical user interface depicting a profile of a content creator and associated measurements of performance obligations. For example, the score and reviews of a content creator can be based on an evaluation of the advertiser campaign performance obligations met including, but not limited to, timeliness, meeting of deadlines, and responsiveness to communications.

As the performance of both advertisers and content creators changes over time, the outcome analysis allows the software application to update the advertiser database and content creator database as needed with changes to the advertiser score and content creator score. The updated content creator score and advertiser score is intended to reflect the success of past advertiser campaigns, rate of payment and electronic payment processing, quantitative outcomes of previous advertiser campaigns, return on investment, and responsiveness. As part of the outcomes analysis, it is to be understood that information from the advertiser campaign can be stored on the campaign database 270 for transparency purposes. That is, the software application can include a newsfeed of advertiser campaigns occurring in real time on the software application of the present disclosure. For example, users may be able to publicly see active advertiser campaigns that are showcased by content creators or advertisers to their user profile on the software application. This includes the ability for a user to directly buy products that are being sold in an ongoing advertiser campaign. As shown in FIG. 13, there can be a buy now feature that allows for a follower of a content creator to directly purchase a product that is being sold in the advertiser campaign.

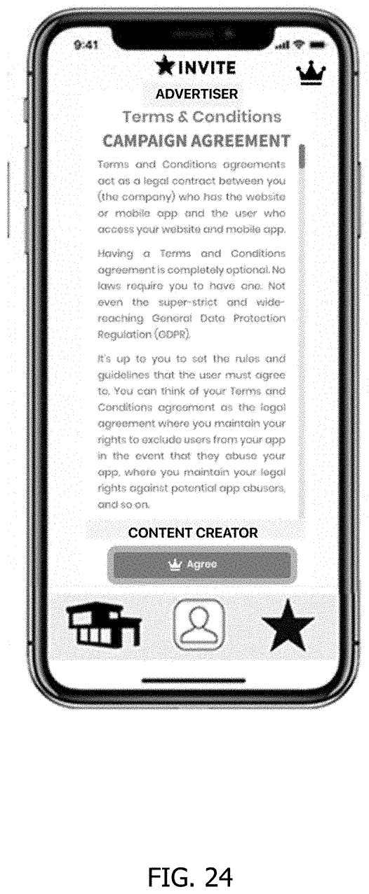

The campaign database 270 can also be used to store terms of previous smart contracts executed by an advertiser and content creator in connection with previously conducted advertiser campaigns. These stored terms may facilitate generating future campaign offers and generating a smart contract for future advertiser campaigns based on outcomes associated with previous advertiser campaigns. These stored terms can include, but are not limited to, rate of pay, number of posts for an advertiser campaign, timing of posts, performance obligations and other factors negotiated in an advertiser campaign proposal. FIG. 24 illustrates an example graphical user interface of a smart contract agreement generated for a content creator and advertiser. The smart contract agreement can include automatically generated terms such as the number of posts and rate of pay associated with an advertiser campaign.

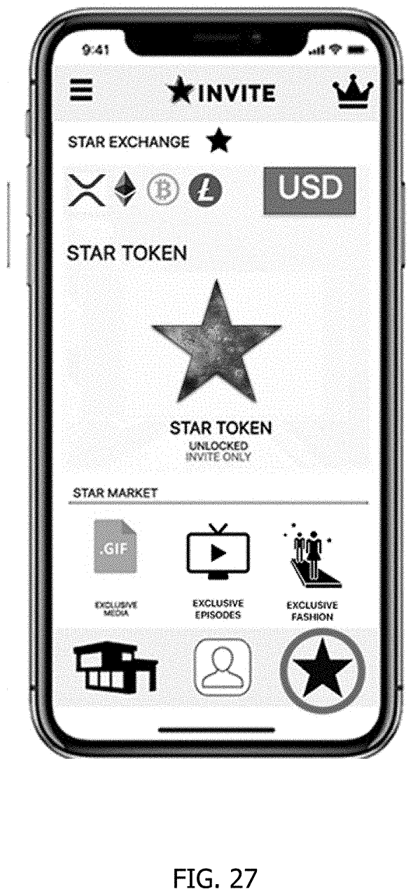

It is to be further understood that the campaign database 270 and the campaign management module 280 may facilitate the use of cryptocurrency. For example, the advertiser and the content creator can optionally have the ability to sell exclusive merchandise, non-fungible tokens stored on a blockchain, music, and graphical interchange formats. It is contemplated that non-fungible tokens may be purchased and exchanged using cryptocurrency protocols known to someone of ordinary skill in the art as well as certain types of fiat currency. FIG. 27 illustrates an example graphical user interface depicting the use of blockchain technology in connection with an advertiser campaign.

Consumers are increasingly relying on peer-to-peer communications. For this reason, among other reasons, regulating content creator transactions, and/or analytics on compensation and disclosure policies, may be useful to update guidance on sponsorship negotiations, and/or to lead the future of content creator marketing. It is further contemplated that smart contracts can be used to describe computer code that (e.g., automatically) may execute some or all parts of an agreement and/or may be stored on a blockchain-based platform. It is to be understood that the smart contract can be the sole manifestation of the agreement between the parties in connection with an advertiser campaign or may complement a traditional text-based contract and only execute certain provisions, such as transferring funds from an advertiser to a content creator.

The machine learning industry and ecosystem of content creator marketing is in transformative growth. Disruption begins with the pricing algorithm. One or more techniques may be directed to account for and/or more particularly explore artificial intelligence processing and hosting services to automate the inputting, managing, and outputting of account transaction data and ranking, rating and reports. Dispensation of aggregated data to extract a set of data pertaining to the given brand in relation to the advertiser campaign agreement, on behalf of activity data, transactional data, and conversational data, can be used for continuous improvement of the scoring algorithm (intermediary scores weightings) based on factors such as electronic payment processing.

After an advertiser campaign has finished, a content creator marketing platform such as the present disclosure will provide all the necessary success metrics based on reach and so on to facilitate improved future advertiser campaign outcomes.

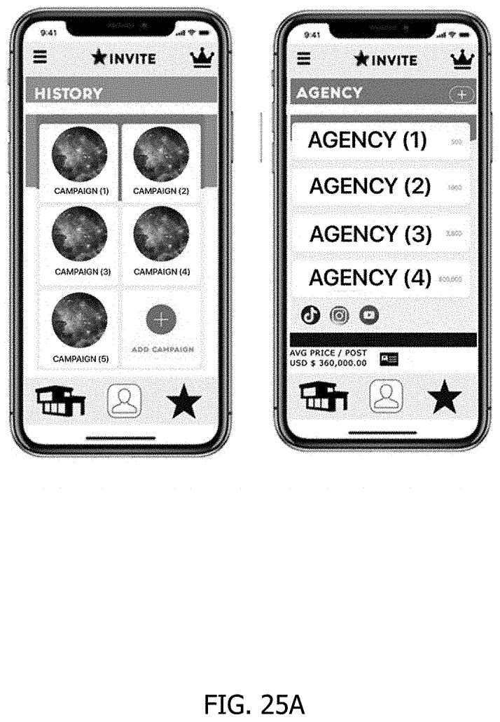

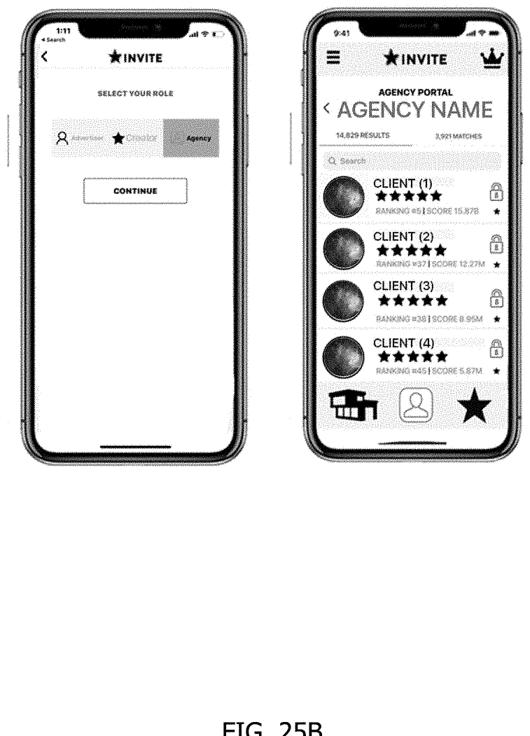

In accordance with another aspect, the software application may include an agency portal. FIGS. 25A and 25B illustrate an example graphical user interface of an agency portal depicting previous advertiser campaigns associated with an advertiser and/or a content creator. The agency portal facilitates a strategy for strengthening personal branding of one or more content creators. It can showcase a profile page and (e.g., directly) links one or more, or all, content creators, and advertiser social media profiles. It is be understood that an agency can link its full roster to the agency portal to showcase its roster of advertisers and/or content creators. For example, this may facilitate the ability for an agency to create advertiser campaigns for one or more content creators. The content creators can showcase their agencies and link their profile directly to an agency page. It is to be further understood that the agency page can showcase multiple content creators. In accordance with an aspect, agencies may be scored, rated, and/or recommended from and/or for content creators.

In accordance with an aspect of the exemplary embodiments of the present disclosure, the methods and applications described herein therefore include storing in computer memory a first electronic version of advertiser data and content creator data via the communications network. The method subsequently includes, after storing in computer memory the first electronic version, accessing again the first electronic version of advertiser data and content creator data via the communications network. The method then includes updating the first electronic version of advertiser data and content creator data via the communications network with updated information related to the advertiser and content creator following completion of an advertiser campaign. Thus, as advertiser campaigns are completed, the advertiser data and content creator data are updated from time to time as needed to guide future collaborative activities.

Those skilled in the art will appreciate that the disclosed subject matter improves upon methods and/or apparatuses for association/matching of one or more advertisers with one or more content creators.

Those skilled in the art will appreciate that the subject matter described herein may at least facilitate an association/matching between an advertiser with one or more content creators. These associations may be useful to the advertiser with, for example, increased sales. These associations may be useful to the content creators with, for example, increased advertising exposure and/or additional revenue.

The subject matter of this disclosure, and components thereof, can be realized by instructions that upon execution cause one or more processing devices to carry out the processes and/or functions described herein. Such instructions can, for example, comprise interpreted instructions, such as script instructions, e.g., JavaScript or ECMAScript instructions, or executable code, and/or other instructions stored in a computer readable medium.

Implementations of the subject matter and/or the functional operations described in this specification and/or the accompanying figures can be provided in digital electronic circuitry, in computer software, firmware, and/or hardware, including the structures disclosed in this specification and their structural equivalents, and/or in combinations of one or more of them. The subject matter described in this specification can be implemented as one or more computer program products, e.g., one or more modules of computer program instructions encoded on a tangible program carrier for execution by, and/or to control the operation of, data processing apparatus.

A computer program (also known as a program, software, software application, script, or code) can be written in any form of programming language, including compiled or interpreted languages, and/or declarative or procedural languages. It can be deployed in any form, including as a stand-alone program or as a module, component, subroutine, and/or other unit suitable for use in a computing environment. A computer program may or may not correspond to a file in a file system. A program can be stored in a portion of a file that holds other programs and/or data (e.g., one or more scripts stored in a markup language document), in a single file dedicated to the program in question, and/or in multiple coordinated files (e.g., files that store one or more modules, sub programs, or portions of code). A computer program can be deployed to be executed on one computer or on multiple computers that may be located at one site or distributed across multiple sites and/or interconnected by a communication network.

The processes and/or logic flows described in this specification and/or in the accompanying figures may be performed by one or more programmable processors executing one or more computer programs to perform functions by operating on input data and/or generating output, thereby tying the process to a particular machine (e.g., a machine programmed to perform the processes described herein). The processes and/or logic flows can also be performed by, and apparatus can also be implemented as, special purpose logic circuitry, e.g., an FPGA (field programmable gate array) and/or an ASIC (application specific integrated circuit).

Computer readable media suitable for storing computer program instructions and/or data may include all forms of non-volatile memory, media and memory devices, including by way of example semiconductor memory devices (e.g., EPROM, EEPROM, and/or flash memory devices); magnetic disks (e.g., internal hard disks or removable disks); magneto optical disks; and/or CD ROM and DVD ROM disks. The processor and/or the memory can be supplemented by, or incorporated in, special purpose logic circuitry.

In sum, the present disclosure provides an effective intermediary platform for associating advertisers and content creators to effectively target groups of consumers. Advantageously, the present disclosure allows for advertisers to effectively spend money towards marketing in areas that drive revenues and impact purchasing decisions. The present disclosure is especially beneficial because it associates content creators directly to advertisers for marketing their product using data-driven algorithms to drive better buyer-seller matches.

Furthermore, while this specification and the accompanying figures contain many specific implementation details, these should not be construed as limitations on the scope of any invention and/or of what may be claimed, but rather as descriptions of features that may be specific to described example implementations. Certain features that are described in this specification in the context of separate implementations can also be implemented in combination in perhaps one implementation. Various features that are described in the context of perhaps one implementation can also be implemented in multiple combinations separately or in any suitable sub-combination. Although features may be described above as acting in certain combinations and/or perhaps even (e.g., initially) claimed as such, one or more features from a claimed combination can in some cases be excised from the combination. The claimed combination may be directed to a sub-combination and/or variation of a sub-combination.

While the disclosure is described herein, using a limited number of exemplary embodiments, these specific embodiments are not intended to limit the scope of the disclosure as otherwise described and claimed herein. The precise arrangement of various elements and order of the steps of systems and methods described herein are not to be considered limiting. For instance, although the steps of the methods are described with reference to a sequential series of reference signs and progression of the blocks in the figures, the method can be implemented in any order as desired.

While the present disclosure has been illustrated and described in detail in the drawings and foregoing description, the same is to be considered as illustrative and not restrictive in character, it being understood that only certain examples have been shown and described, and that all changes and modifications that come within the spirit of the present disclosure are desired to be protected.

What is claimed is:

1. A method performed by at least one control device, the control device being in communication with a communications network, the method comprising:
receiving, by the control device, one or more advertiser campaign proposals via the communications network;
determining, by the control device, one or more social media provider networks adapted for at least one of the one or more advertiser campaign proposals;
determining, by the control device, at least one social media content creator associated with at least one of the one or more social media provider networks; and
associating, by the control device, the at least one social media content creator with a producer of at least one of the one or more advertiser campaign proposals.

2. The method of claim 1, wherein the step of receiving, by the control device, one or more advertiser campaign proposals, includes receiving inputs indicative of a plurality of predetermined campaign parameters.

3. The method of claim 1, wherein the step of associating, by the control device, the at least one social media content creator with the producer of at least one of the one or more advertiser campaign proposals, includes:
receiving advertiser inputs indicative of a plurality of predetermined advertiser preferences of the one or more advertiser campaign proposals;
receiving user inputs indicative of a plurality of predetermined user preferences of the at least one social media content creator;
analyzing a content creator score associated with a social networking profile of the at least one social media content creator;
analyzing an advertiser score associated with a business profile of the one or more advertiser campaign proposals;
applying a filter to the at least one social media content creator, based on:
the predetermined advertiser preferences of the one or more advertiser campaign proposals,
the predetermined user preferences of the at least one social media content creator,
the content creator score associated with the social networking profile of the at least one social media content creator, and
the advertiser score associated with the business profile of the one or more advertiser campaign proposals; and
based on the filter, compiling a preliminary list of recommended matches, wherein the preliminary list of recommended matches includes a match value associated with each of the at least one social media content creators.

4. The method of claim 1, further comprising the step of generating, by the control device, an offer based on criteria stored on a campaign database.

5. A method, comprising:
obtaining an advertiser preference profile for social media content creators with a software application running on one or more computing devices, wherein the advertiser preference profile includes a desired value of one or more attributes associated with social media content creators;
accessing a database of social media content creators, the database including a generated value corresponding to each social media content creator, wherein the generated value corresponds to the one or more attributes associated with social media content creators, determining an association between the desired value and the generated value of at least one of the social media content creators; and
based on the association between the desired value and the generated value, identifying one or more social media content creators from a plurality of social media content creators obtained from the database.

6. The method of claim 5, further comprising:
applying a filter to the one or more social media content creators identified from the database, based on a content creator score associated with a social networking profile of each of the one or more social media content creators; and
based on the filter, compiling a preliminary list of recommended social media content creators, wherein the preliminary list of recommended social media content creators includes at least one or more social media content creators obtained from the database.

7. The method of claim 5, wherein identifying one or more social media content creators from the plurality of social media content creators obtained from the database further includes:
determining a match value for each of the one or more social media content creators from the database, wherein the match value is based on a relative variance between the advertiser preference profile and the attributes of each of the social media content creators in the database.

8. The method of claim 7, wherein the relative variance is a quantitative parameter indicative of a difference between the desired value of the advertiser preference profile and the generated value of the social media content creator.

9. The method of claim 8, wherein the quantitative parameter is a sum of an absolute value of the difference between the desired value of the advertiser preference profile and the generated value of the social media content creator.

10. The method of claim 7, further comprising compiling a list of recommended social media content creators where the relative variance between the desired value of the advertiser preference profile and the generated value of the social media content creator is within a predetermined threshold.

11. The method of claim 5, further comprising implementing a machine reading module to extract one or more attributes associated with social media content creators based on a social networking profile of the social media content creator.

12. The method of claim 5, further comprising the step of generating an offer based on criteria retrieved from a campaign database.

13. A system, comprising:
a content creator database of one or more social media content creators, wherein the one or more social media content creators each include a plurality of predetermined user preferences and a plurality of user attributes associated with a social networking profile of each social media content creator;
an advertiser database of one or more advertiser campaign proposals, wherein the one or more advertiser campaign proposals each include a plurality of predetermined advertiser preferences and a plurality of advertiser attributes associated with a business profile of each advertiser campaign proposal; and
a software application configured to:
a) obtain a user preference profile for social media content creators wherein the user preference profile includes the plurality of predetermined user preferences and the plurality of user attributes;
b) obtain an advertiser preference profile for advertiser campaign proposals wherein the advertiser preference profile includes the plurality of predetermined advertiser preferences and the plurality of advertiser attributes;
c) determine an association between the advertiser preference profile and the user preference profile for the one or more social media content creators; and
d) based on the association between the advertiser preference profile and the user preference profile for the one or more social media content creators, identify one or more social media content creators from a plurality of social media content creators obtained from the content creator database.

14. The system of claim 13, wherein the software application is configured to, in identifying the one or more social media content creators from the plurality of social media content creators obtained from the content creator database, determine a match value for each of the plurality of social media content creators from the content creator database, wherein the match value is based on a relative variance between the advertiser preference profile and the user preference profile of the social media content creators.

15. The system of claim 14, wherein the relative variance is a quantitative parameter indicative of a difference between a desired value corresponding to the advertiser preference profile and a generated value corresponding to the user preference profile of the social media content creator.

16. The system of claim 15, wherein the software application is configured to compile a list of recommended social media content creators where the relative variance between the desired value and the generated value is within a predetermined threshold.

17. The system of claim 16, further comprising a graphical user interface configured to:
display the list of recommended social media content creators to a producer of the advertiser campaign proposals;
display an offer list of advertiser campaign proposals to the social media content creators identified in the list of recommended social media content creators;
receive inputs indicative of a selection by the social media content creator; and
receive inputs indicative of a selection by the producer of the advertiser campaign proposal;
wherein the software application is configured to 1) compare the received inputs from the social media content creator with the received inputs from the producer of the advertiser campaign proposal, 2) based on a comparison, identifying a preliminary match between the social media content creator and the producer of the advertising campaign proposal, and 3) establishing an interaction between the social media content creator and the producer.

18. The system of claim 13, further comprising a campaign database, wherein the software application is configured to generate an offer based on criteria retrieved from the campaign database.

19. The system of claim 13, further comprising a computer process configured to execute the software application.

20. A non-transitory computer program product embodied on a computer readable medium, which, when executed on a computer processor is configured to implement system of claim 13.
